(19) United States
(12) Patent Application Publication
(10) Pub. No.: US 2022/0150487 A1
(43) Pub. Date: May 12, 2022

(54) IMAGE ENCODING METHOD, IMAGE DECODING METHOD, AND DEVICE FOR PROCESSING PICTURE PARTITIONS

(71) Applicant: KAONMEDIA CO., LTD., Seongnam-si (KR)

(72) Inventors: Hoa Sub LIM, Seongnam-si (KR); Jeong Yun LIM, Seoul (KR)

(21) Appl. No.: 17/441,273

(22) PCT Filed: Mar. 23, 2020
(86) PCT No.: PCT/KR2020/003947

§ 371 Date: Oct. 25, 2021

(30) Foreign Application Priority Data
Mar. 21, 2019 (KR) 10-2019-0032443

(51) Int. Cl. H04N 19/119; H04N 19/174; H04N 19/172; H04N 19/85; H04N 19/136; H04N 19/169; H04N 19/109; H04N 19/436; H04N 19/70; H04N 19/11

(52) U.S. Cl. CPC H04N 19/119; H04N 19/174; H04N 19/172; H04N 19/85; H04N 19/11; H04N 19/1883; H04N 19/109; H04N 19/436; H04N 19/70; H04N 19/136

(57) ABSTRACT

An image decoding method according to an embodiment of the present invention comprises the steps of: decoding sub-picture information and processing of multiple sub-pictures that cover a specific area of a picture of an image, wherein the sub-picture information includes tiles or slices for partition of the picture; and on the basis of the sub-picture information, identifying the multiple sub-pictures, and decoding each of the tiles or slices constituting the sub-pictures, wherein the sub-picture information includes level information indicating processing levels corresponding to the multiple sub-pictures.

### TECHNICAL FIELD

The present invention relates to image encoding and decoding, and more particularly, to a method of performing prediction and transform by partitioning a moving picture into a plurality of areas.

### BACKGROUND ART

An image compression method performs encoding by dividing one picture into a plurality of areas having a predetermined size. In addition, the image compression method uses inter prediction and intra prediction techniques that remove redundancy among pictures in order to increase compression efficiency.

In this case, a residual signal is generated using intra prediction and inter prediction, and the reason of obtaining the residual signal is that when coding is performed with the residual signal, the data compression rate increases as the amount of data is small, and the better the prediction, the smaller the value of the residual signal will be.

The intra prediction method predicts data of a current block using pixels around the current block. The difference between an actual value and a predicted value is called as a residual signal block. In the case of the HEVC, the intra prediction method performs prediction in more detail as the prediction mode increases from 9 prediction modes used in the existing H.264/AVC to 35 prediction modes.

In the case of the inter prediction method, the most similar block is found by comparing the current block with blocks in the neighboring pictures. At this point, position information (Vx, Vy) of the found block is referred to as a motion vector. The difference in the pixel values of a block between the current block and a prediction block predicted by the motion vector is referred to as a residual signal block (motion-compensated residual block).

As described above, although the amount of data of the residual signal decreases as intra prediction and inter prediction are further subdivided, the amount of computation for processing a moving image increases greatly.

Particularly, there are difficulties in implementing a pipeline or the like due to the increase in complexity in the process of determining an intra-picture partition structure for image encoding and decoding, and an existing block partition method and the size and shape of a block partitioned according thereto may not be suitable for encoding an image of high resolution.

In addition, in order to support virtual reality such as 360-degree VR images or the like, processing of ultrahigh-resolution images obtained by preprocessing, projecting and merging a plurality of high-resolution images in real-time is required, and predictive transform and quantization processing processes according to the current block structure may be inefficient for processing the ultrahigh-resolution images.

### DISCLOSURE OF INVENTION

### Technical Problem

Therefore, the present invention has been made in view of the above problems, and it is an object of the present invention to provide an image processing method suitable for encoding and decoding ultrahigh-resolution images and processing efficient image partition for this purpose, and an image decoding and encoding method using the same.

### Technical Solution

To accomplish the above object, according to one aspect of the present invention, there is provided an image decoding method comprising the steps of: decoding subpicture information for processing a plurality of subpictures that include tiles or slices partitioning a picture of an image and cover a specific area of the picture; and identifying the plurality of subpictures and decoding each of the tiles or slices configuring the subpictures on the basis of the subpicture information, wherein the subpicture information includes level information indicating processing levels corresponding to the plurality of subpictures.

According to another aspect of the present invention, there is provided an image decoding apparatus comprising: a picture partition unit for decoding subpicture information for processing a plurality of subpictures that include tiles or slices partitioning a picture of an image and cover a specific area of the picture; and a decoding processing unit for identifying the plurality of subpictures and decoding each of the tiles or slices configuring the subpictures on the basis of the subpicture information, wherein the subpicture information includes level information indicating processing levels corresponding to the plurality of subpictures.

### Advantageous Effects

According to an embodiment of the present invention, as picture partition and parallel processing can be performed more efficiently, efficiency of encoding and decoding high-resolution images can be improved.

Particularly, as each of the partitioned subpictures is configured in various conditions and shapes and appropriate subpicture information corresponding thereto is indicated, an adaptive and efficient image decoding process can be performed according to the performance and environment of a decoding apparatus.

### BRIEF DESCRIPTION OF THE DRAWINGS

FIG. 1 is a block diagram showing the configuration of an image encoding apparatus according to an embodiment of the present invention.

FIGS. 2 to 5 are views for explaining a first embodiment of a method of partitioning and processing an image in units of blocks.

FIG. 6 is a view for explaining an embodiment of a method of performing inter prediction in an image encoding apparatus.

FIG. 7 is a block diagram showing the configuration of an image decoding apparatus according to an embodiment of the present invention.

FIG. 8 is a view for explaining an embodiment of a method of performing inter prediction in an image decoding apparatus.

FIG. 9 is a view for explaining a second embodiment of a method of partitioning and processing an image in units of blocks.

FIG. 10 is a view showing an embodiment of a syntax structure used to divide and process an image in units of blocks.

FIG. 11 is a view for explaining a third embodiment of a method of partitioning and processing an image in units of blocks.

FIG. 12 is a view for explaining an embodiment of a method of constructing a transform unit by partitioning a coding unit in a binary tree structure.

FIG. 13 is a view for explaining a fourth embodiment of a method of partitioning and processing an image in units of blocks.

FIGS. 14 to 16 are views for explaining still other embodiments of a method of partitioning and processing an image in units of blocks.

FIGS. 17 and 18 are views for explaining embodiments of a method of determining a partition structure of a transform unit by performing Rate Distortion Optimization (RDO).

FIG. 19 is a view for explaining a composite partition structure according to another embodiment of the present invention.

FIG. 20 is a flowchart illustrating the process of encoding tile group information according to an embodiment of the present invention.

FIGS. 21 to 25 are views for explaining a tile group example and tile group information according to an embodiment of the present invention.

FIG. 26 is a flowchart illustrating a decoding process based on tile group information according to an embodiment of the present invention.

FIG. 27 is a flowchart illustrating the process of initializing a tile group header according to an embodiment of the present invention.

FIG. 28 is a view for explaining variable parallel processing based on parallelization layer units according to an embodiment of the present invention.

FIG. 29 is a view for explaining a case of mapping tile group information and user perspective information according to an embodiment of the present invention.

FIG. 30 is a view showing syntax of tile group header information according to an embodiment of the present invention.

### BEST MODE FOR CARRYING OUT THE INVENTION

Hereinafter, embodiments of the present invention will be described in detail with reference to the drawings. In describing the embodiments of the present specification, when it is determined that a detailed description of a related known configuration or function may obscure the gist of the present specification, the detailed description will be omitted.

When it is mentioned that a component is “connected” or “coupled” to another component, it may be directly connected or coupled to another component, but it should be understood that other components may exist therebetween. In addition, the description of “including” a specific configuration in the present invention does not exclude configurations other than the corresponding configuration, and means that additional configurations may be included in the embodiments of the present invention or the scope of the technical spirit of the present invention.

Although terms such as first, second, and the like may be used to describe various components, the components should not be limited by the terms. The terms are used only to distinguish one component from the others. For example, a first component may be referred to as a second component, and similarly, a second component may also be referred to as a first component without departing from the scope of the present invention.

The configuration units in the embodiments of the present invention are independently shown to represent characteristic functions different from each other, and it does not mean that each configuration unit is formed by the configuration unit of separate hardware or single software. That is, each configuration unit is included to be arranged as a configuration unit for convenience of explanation, and at least two of the configuration unit may be combined to form a single configuration unit, or one configuration unit may be divided into a plurality of configuration units to perform a function. Integrated embodiments and separate embodiments of the configuration units are also included in the scope of the present invention if they do not depart from the essence of the present invention.

In addition, some of the components are not essential components that perform essential functions in the present invention, but may be optional components only for improving performance. The present invention may be implemented by including only the components essential to implement the essence of the present invention excluding the components used for improving performance, and a structure including only the essential components other than the optional components used for improving performance is also included in the scope of the present invention.

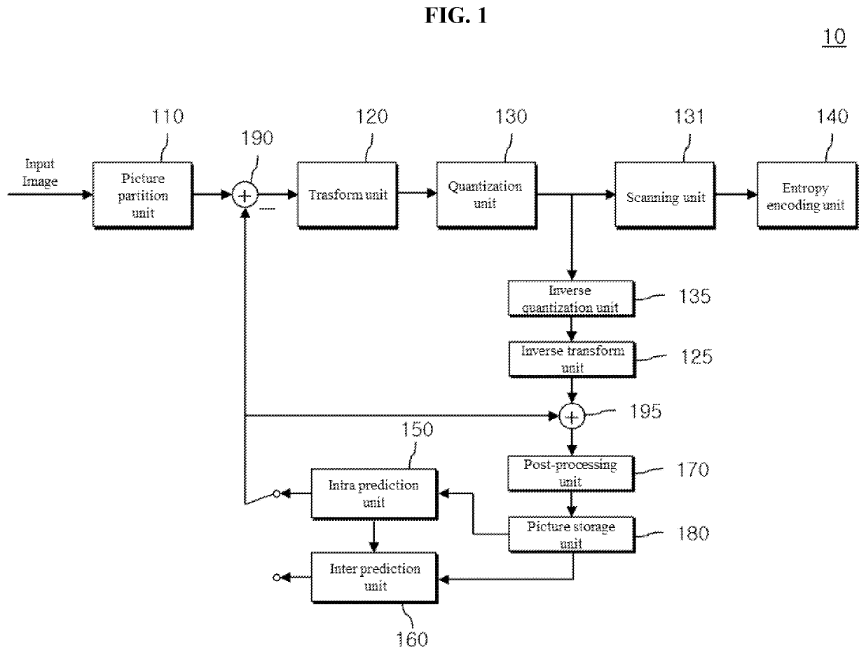

FIG. 1 is a block diagram showing the configuration of an image encoding apparatus according to an embodiment of the present invention. An image encoding apparatus 10 includes a picture partition unit 110, a transform unit 120, a quantization unit 130, a scanning unit 131, an entropy encoding unit 140, an intra prediction unit 150, an inter prediction unit 160, an inverse quantization unit 135, an inverse transform unit 125, a post-processing unit 170, a picture storage unit 180, a subtraction unit 190, and an addition unit 195.

Referring to FIG. 1, the picture partition unit 110 analyzes an input video signal, divides a picture into coding units, determines a prediction mode, and determines the size of a prediction unit for each coding unit.

In addition, the picture partition unit 110 transmits a prediction unit to be encoded to the intra prediction unit 150 or the inter prediction unit 160 according to a prediction mode (or prediction method). In addition, the picture partition unit 110 transmits the prediction unit to be encoded to the subtraction unit 190.

Here, a picture of an image may be configured of a plurality of tiles or slices, and the tiles or slices may be partitioned into a plurality of coding tree units (CTUs), which are basic units for partitioning a picture.

In addition, the plurality of tiles or slices according to an embodiment of the present invention may configure one or more tile or slice groups, and such a group may configure subpictures that divide the picture into rectangular areas. In addition, a parallelization processing process of a subpicture based on a tile or slice group may be performed, which will be described below.

In addition, the coding tree unit may be partitioned into one or two or more coding units (CUs), which are basic units for performing inter prediction or intra prediction.

A coding unit (CU) may be partitioned into one or more prediction units (PUs), which are basic units for performing prediction.

In this case, although the encoding apparatus 10 determines any one among the inter prediction and the intra prediction as a prediction method for each of the partitioned coding units (CUs), the encoding apparatus 10 may generate a different prediction block for each prediction unit (PU).

Meanwhile, the coding unit (CU) may be partitioned into one or two or more transform units (TUs), which are basic units for performing transform on a residual block.

In this case, the picture partition unit 110 may transfer image data to the subtraction unit 190 in units of blocks (e.g., prediction unit (PU) or transform unit (TU)) partitioned as described above.

Referring to FIG. 2, a coding tree unit (CTU) having a maximum pixel size of 256×256 may be partitioned in a quad tree structure to be partitioned into four coding units (CUs) having a square shape.

Each of the four coding units (CUs) having a square shape may be partitioned again in a quad tree structure, and the depth of the coding unit (CU) partitioned in a quad tree structure as described above may have any one integer value of 0 to 3.

A coding unit (CU) may be partitioned into one or more prediction units (PUs) according to a prediction mode.

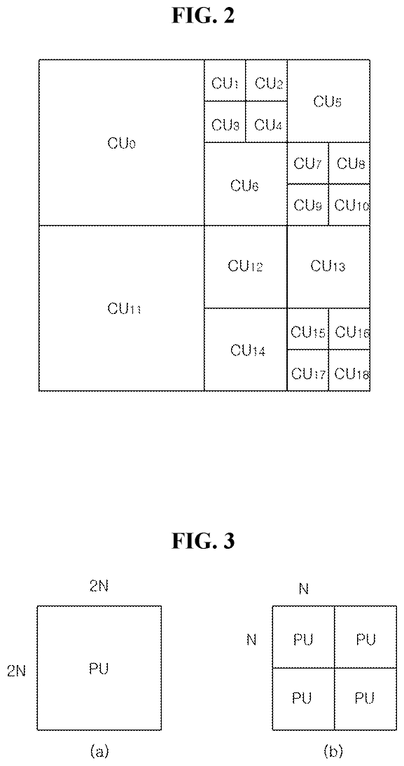

In the case of the intra prediction mode, when the size of the coding unit (CU) is 2N×2N, the prediction unit (PU) may have a size of 2N×2N shown in FIG. 3(a) or N×N shown in FIG. 3(b).

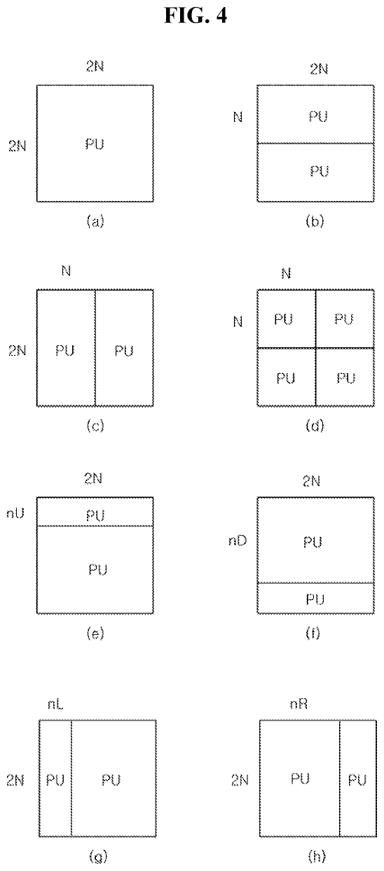

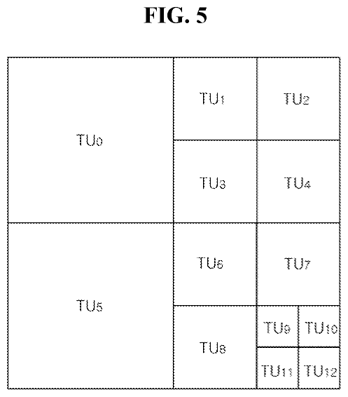

On the other hand, in the case of the inter prediction mode, when the size of the coding unit (CU) is 2N×2N, the prediction unit (PU) may have a size of any one among 2N×2N shown in FIG. 4(a), 2N×N shown in FIG. 4(b), N×2N shown in FIG. 4(c), N×N shown in FIG. 4(d), 2N×nU shown in FIG. 4(e), 2N×nD shown in FIG. 4(f), nL×2N shown in FIG. 4(g), and nR×2N shown in of FIG. 4(h).

Referring to FIG. 5, a coding unit (CU) may be partitioned in a quad tree structure to be partitioned into four transform units (TUs) having a square shape.

Each of the four transform units (TUs) having a square shape may be partitioned again in a quad tree structure, and the depth of the transform unit (TU) partitioned in a quad tree structure as described above may have any one integer value of 0 to 3.

Here, when the coding unit (CU) is in the inter prediction mode, the prediction unit (PU) and the transform unit (TU) partitioned from the coding unit (CU) may have partition structures independent from each other.

When the coding unit (CU) is the intra prediction mode, the size of the transform unit (TU) partitioned from the coding unit (CU) cannot be larger than the size of the prediction unit (PU).

In addition, the transform unit (TU) partitioned as described above may have a maximum pixel size of 64×64.

The transform unit 120 transforms a residual block that is a residual signal between the original block of the input prediction unit (PU) and the prediction block generated by the intra prediction unit 150 or the inter prediction unit 160, and the transform may be performed using the transform unit (TU) as a basic unit.

In the transform process, different transform matrices may be determined according to (intra or inter) prediction modes, and since the residual signal of intra prediction has directionality according to the intra prediction mode, a transform matrix may be adaptively determined according to the intra prediction mode.

The transform unit may be transformed by two (horizontal and vertical) one-dimensional transform matrices, and for example, in the case of the inter prediction, one predetermined transform matrix may be determined.

On the other hand, in the case of the intra prediction, when the intra prediction mode is horizontal, as the probability of the residual block for having directionality in the vertical direction increases, a DCT-based integer matrix is applied in the vertical direction, and a DST-based or KLT-based integer matrix is applied in the horizontal direction. When the intra prediction mode is vertical, a DST-based or KLT-based integer matrix may be applied in the vertical direction, and a DCT-based integer matrix may be applied in the horizontal direction.

In addition, in the case of the DC mode, a DCT-based integer matrix may be applied in both directions.

In addition, in the case of the intra prediction, a transform matrix may be adaptively determined on the basis of the size of the transform unit (TU).

The quantization unit 130 determines a quantization step size for quantizing the coefficients of the residual block transformed by the transform matrix, and the quantization step size may be determined for each quantization unit of a predetermined size or larger.

The size of the quantization unit may be 8×8 or 16×16, and the quantization unit 130 quantizes the coefficients of the transform block using a quantization matrix determined according to the quantization step size and the prediction mode.

In addition, the quantization unit 130 may use the quantization step size of a quantization unit adjacent to the current quantization unit as a quantization step size predictor of the current quantization unit.

The quantization unit 130 may search in the order of a left quantization unit, an upper quantization unit, and an top-left quantization unit of the current quantization unit, and generate the quantization step size predictor of the current quantization unit using one or two valid quantization step sizes.

For example, the quantization unit 130 may determine a valid first quantization step size searched in the above order as the quantization step size predictor, determine an average value of two valid quantization step sizes searched in the above order as the quantization step size predictor, or determine, when only one quantization step size is valid, the quantization step size as the quantization step size predictor.

When the quantization step size predictor is determined, the quantization unit 130 transmits a differential value between the quantization step size of the current quantization unit and the quantization step size predictor to the entropy encoding unit 140.

On the other hand, all the left coding unit, the upper coding unit, and the top-left coding unit of the current coding unit may not exist, or there may be a coding unit that exists before in the encoding order within the largest coding unit.

Accordingly, in the quantization units adjacent to the current coding unit and the largest coding unit, the quantization step size of the quantization unit immediately before in the encoding order may be a candidate.

In this case, the priority may be set in order of 1) the left quantization unit of the current coding unit, 2) the upper quantization unit of the current coding unit, 3) the top-left quantization unit of the current coding unit, and 4) the quantization unit immediately before in the encoding order. The order may be changed, and the top-left quantization unit may be omitted.

Meanwhile, the transform block quantized as described above is transferred to the inverse quantization unit 135 and the scanning unit 131.

The scanning unit 131 scans and transforms the coefficients of the quantized transform block into one-dimensional quantized coefficients. In this case, since the coefficient distribution of the transform block after quantization may depend on the intra prediction mode, the scanning method may be determined according to the intra prediction mode.

In addition, the coefficient scanning method may be determined in a different way according to the size of the transform unit, and the scanning pattern may vary according to the directional intra prediction mode. In this case, scanning of the quantization coefficients may be performed in a reverse direction.

When the quantized coefficients are partitioned into a plurality of subsets, the same scanning pattern may be applied to the quantization coefficients in each subset, and a zigzag scan or a diagonal scan may be applied to the scanning pattern between the subsets.

Meanwhile, although the scanning pattern is preferably scanning in a forward direction from the main subset including DC to the remaining subsets, the reverse direction is also possible.

In addition, the scanning pattern between the subsets may be set to be the same as the scanning pattern of the quantized coefficients in the subset, and the scanning pattern between the subsets may be determined according to the intra prediction mode.

On the other hand, the encoding apparatus 10 may include information indicating the position of the last non-zero quantization coefficient in the transform unit (TU←F PU) and the position of the last non-zero quantization coefficient in each subset into the bitstream, and transmit the information to the decoding apparatus 20.

The inverse quantization unit 135 performs inverse quantization on the coefficients quantized as described above, and the inverse transform unit 125 may perform inverse transform in units of transform units (TUs) to reconstruct the inverse quantized transform coefficients as a residual block of the spatial area.

The addition unit 195 may generate a reconstructed block by adding the residual block reconstructed by the inverse transform unit 125 and the prediction block received from the intra prediction unit 150 or the inter prediction unit 160.

In addition, the post-processing unit 170 may perform post-processing such as a deblocking filtering process for removing the blocking effect occurring in the reconstructed picture, a process of applying a sample adaptive offset (SAO) for complementing a difference value from the original image in units of pixels, and an adaptive loop filtering (ALF) process for complementing a difference value from the original image using a coding unit.

The deblocking filtering process may be applied to the boundary of a prediction unit (PU) or a transform unit (TU) having a size greater than or equal to a predetermined size.

For example, the deblocking filtering process may include the steps of determining a boundary to be filtered, determining a boundary filtering strength to be applied to the boundary, determining whether or not to apply a deblocking filter, and selecting a filter to be applied to the boundary when it is determined to apply a deblocking filter.

On the other hand, whether or not to apply a deblocking filter may be determined by i) whether the boundary filtering strength is greater than 0, and ii) whether a value indicating a degree of change in the pixel values at the boundary of two blocks (P block, Q block) adjacent to a boundary to be filtered is smaller than a first reference value determined by a quantization parameter.

It is preferable to provide two or more filters. When the absolute value of the difference value between two pixels located at the block boundary is greater than or equal to a second reference value, a filter that performs relatively weak filtering is selected.

The second reference value is determined by the quantization parameter and the boundary filtering strength.

In addition, the process of applying a sample adaptive offset (SAO) is for reducing the distortion between a pixel in the image to which the deblocking filter is applied and an original pixel, and whether the process of applying a sample adaptive offset (SAO) is performed in units of pictures or slices may be determined.

The picture or slice may be partitioned into a plurality of offset areas, and an offset type may be determined for each offset area, and the offset type may include a predetermined number (e.g., four) of edge offset types and two band offset types.

For example, when the offset type is an edge offset type, an edge type to which each pixel belongs is determined, and a corresponding offset is applied, and the edge type may be determined on the basis of distribution of values of two pixels adjacent to the current pixel.

In the adaptive loop filtering (ALF) process, filtering may be performed on the basis of a value obtained by comparing the original image with the reconstructed image that has gone through the deblocking filtering process or the process of applying a sample adaptive offset.

The picture storage unit 180 receives the post-processed image data from the post-processing unit 170 to reconstruct and store images in units of pictures, and the pictures may be images of frame units or images of field units.

The inter prediction unit 160 may perform motion estimation using at least one reference picture stored in the picture storage unit 180, and determine a reference picture index and a motion vector indicating a reference picture.

In this case, a prediction block corresponding to a prediction unit to be encoded may be extracted from a reference picture used for motion estimation among a plurality of reference pictures stored in the picture storage unit 180 according to the determined reference picture index and motion vector.

The intra prediction unit 150 may perform intra prediction encoding using the reconstructed pixel value inside the picture including the current prediction unit.

The intra prediction unit 150 may receive a current prediction unit to be predictively encoded, and perform intra prediction by selecting one of a preset number of intra prediction modes according to the size of the current block.

The intra prediction unit 150 adaptively filters a reference pixel to generate an intra prediction block, and may generate a reference pixel using available reference pixels when the reference pixel is not available.

The entropy encoding unit 140 may perform entropy encoding on the quantization coefficients quantized by the quantization unit 130, intra prediction information received from the intra prediction unit 150, motion information received from the inter prediction unit 160, and the like.

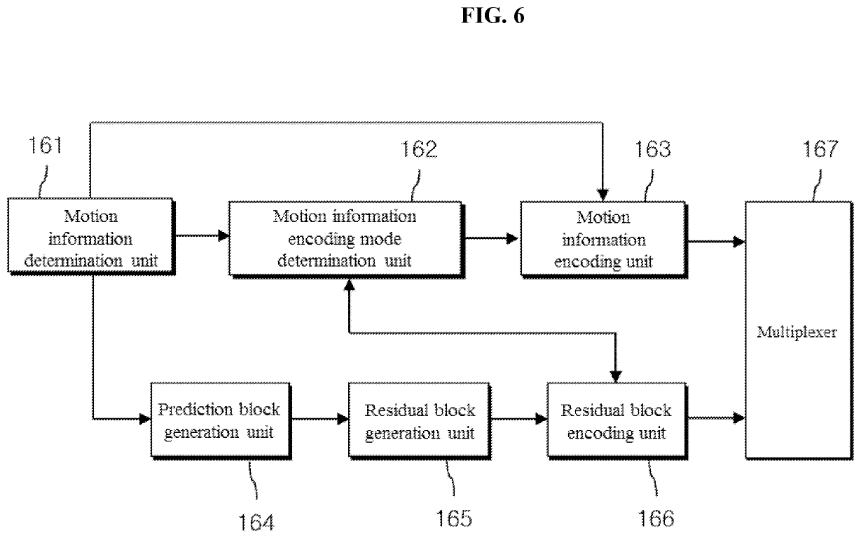

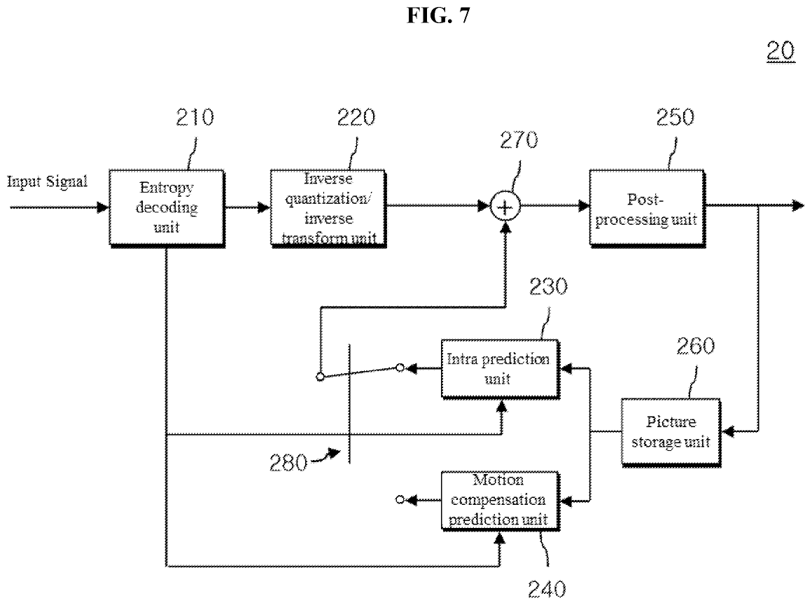

FIG. 6 is a block diagram showing an embodiment of the configuration of performing inter prediction in the encoding apparatus 10, and the inter prediction encoder shown in the drawing may be configured to include a motion information determination unit 161, a motion information encoding mode determination unit 162, a motion information encoding unit 163, a prediction block generation unit 164, a residual block generation unit 165, a residual block encoding unit 166, and a multiplexer 167.

Referring to FIG. 6, the motion information determination unit 161 determines motion information of the current block, and the motion information includes a reference picture index and a motion vector, and the reference picture index may indicate any one of previously encoded and reconstructed pictures.

When unidirectional inter prediction encoding is performed on the current block, it indicates any one of reference pictures belonging to list 0 (L0), and when bidirectional prediction encoding is performed on the current block, it may include a reference picture index indicating one of reference pictures of list 0 (L0) and a reference picture index indicating one of reference pictures of list 1 (L1).

In addition, when bidirectional prediction encoding is performed on the current block, it may include an index indicating one or two pictures among the reference pictures of a composite list LC generated by combining list 0 and list 1.

The motion vector indicates a position of a prediction block in a picture indicated by each reference picture index, and the motion vector may be a pixel unit (integer unit) or a sub-pixel unit.

For example, the motion vector may have a precision of ½, ¼, ⅛, or 1/16 pixels, and when the motion vector is not an integer unit, the prediction block may be generated from pixels of integer unit.

The motion information encoding mode determination unit 162 may determine an encoding mode for the motion information of the current block, and the encoding mode may be exemplified as any one among a skip mode, a merge mode, and an AMVP mode.

The skip mode may be applied when a skip candidate having motion information the same as the motion information of the current block exists and the residual signal is 0, and the skip mode may be applied when the current block, which is a prediction unit (PU), has a size the same as that of the coding unit (CU).

The merge mode is applied when there is a merge candidate having motion information the same as the motion information of the current block, and the merge mode is applied when the size of the current block is different from that of the coding unit (CU), or in the case where the size of the current block is the same size as that of the coding unit (CU), the merge mode is applied when there is a residual signal. Meanwhile, the merge candidate and the skip candidate may be the same.

The AMVP mode is applied when the skip mode and the merge mode are not applied, and an AMVP candidate having a motion vector most similar to the motion vector of the current block may be selected as an AMVP predictor.

However, the encoding mode is a process other than the methods described above, and may adaptively include more subdivided motion compensation prediction encoding modes. The adaptively determined motion compensation prediction mode may further include at least one among a frame rate up-conversion (FRUC) mode, a bidirectional optical flow (BIO) mode, an affine motion prediction (AMP) mode, an overlapped block motion compensation (OBMC) mode, a decoder-side motion vector refinement (DMVR) mode, an alternative temporal motion vector prediction (ATMVP) mode, a spatial-temporal motion vector prediction (STMVP) mode, and a local illumination compensation (LIC) mode currently proposed as new motion compensation prediction modes, as well as the AMVP mode, the merge mode, and the skip mode described above, and may be block-adaptively determined according to a predetermined condition.

The motion information encoding unit 163 may encode the motion information according to the method determined by the motion information encoding mode determination unit 162.

For example, the motion information encoding unit 163 may perform a merge motion vector encoding process when the motion information encoding mode is the skip mode or the merge mode, and may perform an AMVP encoding process when the motion information encoding mode is the AMVP mode.

The prediction block generation unit 164 generates a prediction block using motion information of the current block, and when the motion vector is an integer unit, the prediction block generation unit 164 copies a block corresponding to the position indicated by the motion vector in the picture indicated by the reference picture index to generate a prediction block of the current block.

On the other hand, when the motion vector is not an integer unit, the prediction block generation unit 164 may generate pixels of the prediction block from integer unit pixels in the picture indicated by the reference picture index.

In this case, prediction pixels may be generated using an 8-tap interpolation filter for luminance pixels, and the prediction pixels may be generated using a 4-tap interpolation filter for chrominance pixels.

The residual block generation unit 165 generates a residual block using the current block and the prediction block of the current block, and when the size of the current block is 2N×2N, the residual block may be generated using the current block and a prediction block having a size of 2N×2N corresponding to the current block.

On the other hand, when the size of the current block used for prediction is 2N×N or N×2N, a prediction block is obtained for each of the two 2N×N blocks configuring 2N×2N, and then a final prediction block of a size of 2N×2N may be generated using the two 2N×N prediction blocks.

In addition, a residual block of a size of 2N×2N may be generated using the prediction block of a size of 2N×2N, and overlap smoothing may be applied to the pixels at the boundary in order to resolve discontinuity of the boundary between two prediction blocks having a size of 2N×N.

The residual block encoding unit 166 may divide the residual block into one or more transform units (TUs), and transform encoding, quantization, and entropy encoding may be performed on each transform unit (TU).

The residual block encoding unit 166 may transform the residual block generated by the inter prediction method using an integer-based transform matrix, and the transform matrix may be an integer-based DCT matrix.

Meanwhile, the residual block encoding unit 166 uses a quantization matrix to quantize coefficients of the residual block transformed by the transform matrix, and the quantization matrix may be determined by a quantization parameter.

The quantization parameter is determined for each coding unit (CU) having a size greater than or equal to a predetermined size, and when the current coding unit (CU) is smaller than a predetermined size, only the quantization parameter of a first coding unit (CU) in the encoding order among the coding units (CUs) of a predetermined size or smaller is encoded, and since the quantization parameter of the remaining coding units (CUs) is the same as the parameter described above, encoding of the quantization parameter may not be performed.

In addition, the coefficients of the transform block may be quantized using a quantization matrix determined according to the quantization parameter and a prediction mode.

The quantization parameter determined for each coding unit (CU) having a size greater than or equal to the predetermined size may be predictively encoded using a quantization parameter of a coding unit (CU) adjacent to the current coding unit (CU).

A quantization parameter predictor of the current coding unit (CU) may be generated using one or two valid quantization parameters by searching in the order of the left coding unit (CU) and the upper coding unit (CU) of the current coding unit (CU).

For example, a valid first quantization parameter searched in the above order may be determined as a quantization parameter predictor, and in addition, a valid first quantization parameter may be determined as a quantization parameter predictor by searching in the order of the left coding unit (CU) and the coding unit (CU) immediately before in the encoding order.

The coefficients of the quantized transform block are scanned and transformed into one-dimensional quantization coefficients, and a scanning method may be set differently according to the entropy encoding mode.

For example, when the quantization coefficients are encoded in CABAC, inter-predictively encoded quantization coefficients may be scanned in a predetermined method (raster scan in a zigzag or diagonal direction), and when the quantization coefficients are coded in CAVLC, scanning may be performed in a manner different from the method described above.

For example, the scanning method may be determined according to the zigzag mode in the case of the inter prediction and according to the intra prediction mode in the case of the intra prediction, and the coefficient scanning method may be determined differently according to the size of the transform unit.

Meanwhile, the scanning pattern may vary according to the directional intra prediction mode, and scanning of the quantization coefficients may be performed in a reverse direction.

The multiplexer 167 multiplexes the motion information encoded by the motion information encoding unit 163 and the residual signal encoded by the residual block encoding unit 166.

The motion information may vary according to the encoding mode. For example, in the case of the skip or merge mode, only an index indicating a predictor is included, and in the case of the AMVP mode, it may include the reference picture index, differential motion vector, and AMVP index of the current block.

Hereinafter, an embodiment of the operation of the intra prediction unit 150 shown in FIG. 1 will be described in detail.

First, the intra prediction unit 150 may receive prediction mode information and the size of the prediction unit (PU) from the picture partition unit 110, and read reference pixels from the picture storage unit 180 to determine the intra prediction mode of the prediction unit (PU).

The intra prediction unit 150 examines whether an unavailable reference pixel exists to determine whether or not to generate a reference pixel, and the reference pixels may be used to determine the intra prediction mode of the current block.

When the current block is located at the upper boundary of the current picture, pixels adjacent to the upper side of the current block are not defined, and when the current block is located at the left boundary of the current picture, pixels adjacent to the left side of the current block are not defined, and it may be determined that the pixels are unavailable pixels.

In addition, even when the current block is located at the slice boundary and the pixels adjacent to the upper or left side of the slice are not pixels previously encoded and reconstructed, they may be determined as unavailable pixels.

As described above, when the pixels adjacent to the left or upper side of the current block do not exist or the previously encoded and reconstructed pixels do not exist, the intra prediction mode of the current block may be determined using only available pixels.

Meanwhile, a reference pixel at an unavailable position may be generated using the available reference pixels of the current block. For example, when pixels of the upper block are unavailable, pixels on the upper side may be generated using some or all of the pixels on the left side, and vice versa.

That is, a reference pixel may be generated by copying an available reference pixel at a nearest position in a predetermined direction from a reference pixel at an unavailable position, or when an available reference pixel does not exist in a predetermined direction, a reference pixel may be generated by copying an available reference pixel at a nearest position in the opposite direction.

Meanwhile, even when pixels exist on the upper or left side of the current block, they may be determined as unavailable reference pixels according to the encoding mode of a block to which the pixels belong.

For example, when a block to which a reference pixel adjacent to the upper side of the current block belongs is a block reconstructed by inter prediction encoding, the pixels may be determined as unavailable pixels.

In this case, available reference pixels may be generated using the pixels belonging to the block reconstructed by performing inter prediction encoding on a block adjacent to the current block, and the encoding apparatus 10 transmits information indicating that an available reference pixel is determined according to an encoding mode to the decoding apparatus 20.

The intra prediction unit 150 determines the intra prediction mode of the current block using the reference pixels, and the number of allowable intra prediction modes that can be allowed for the current block may vary according to the size of the block.

For example, when the size of the current block is 8×8, 16×16, or 32×32, the re may exist 34 intra prediction modes, and when the size of the current block is 4×4, there may exist 17 intra prediction modes.

The 34 or 17 intra prediction modes may be configured of at least one non-directional mode and a plurality of directional modes.

The one or more non-directional modes may be a DC mode and/or a planar mode. When the DC mode and the planar mode are included as non-directional modes, there may exist 35 intra prediction modes regardless of the size of the current block.

In this case, two non-directional modes (DC mode and planar mode) and 33 directional modes may be included.

In the case of the planar mode, a prediction block of the current block is generated using at least one pixel value located at the bottom right of the current block (or prediction value of the pixel value, hereinafter, referred to as a first reference value) and the reference pixels.

The configuration of the image decoding apparatus according to an embodiment of the present invention may be derived from the configuration of the image encoding apparatus 10 described with reference to FIGS. 1 to 6, and for example, an image may be decoded by inversely performing the steps of the image encoding method described above with reference to FIGS. 1 to 6.

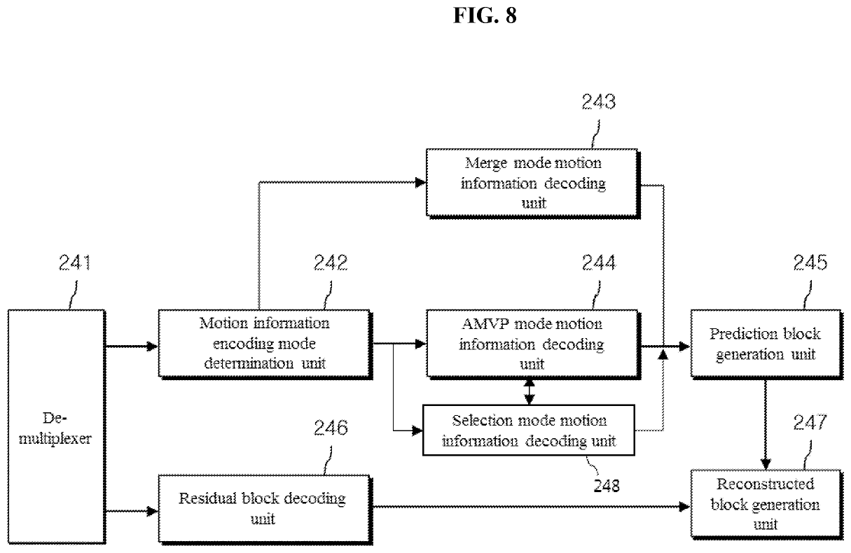

FIG. 7 is a block diagram showing the configuration of an image decoding apparatus according to an embodiment of the present invention. The decoding apparatus 20 includes an entropy decoding unit 210, an inverse quantization/inverse transform unit 220, an adder 270, a post-processing unit 250, a picture storage unit 260, an intra prediction unit 230, a motion compensation prediction unit 240, and an intra/inter transition switch 280.

The entropy decoding unit 210 receives and decodes a bitstream encoded by the image encoding apparatus 10, separates an intra prediction mode index, motion information, quantization coefficient sequence, and the like, and transfers decoded motion information to the motion compensation prediction unit 240.

The entropy decoding unit 210 transfers the intra prediction mode index to the intra prediction unit 230 and the inverse quantization/inverse transform unit 220, and transfers an inverse quantization coefficient sequence to the inverse quantization/inverse transform unit 220.

The inverse quantization/inverse transform unit 220 may transform the quantization coefficient sequence into inverse quantization coefficients of two-dimensional array, and select one of a plurality of scanning patterns for the transform, for example, may select a scanning pattern based on the prediction mode (i.e., intra prediction or inter prediction) of the current block and the intra prediction mode.

The inverse quantization/inverse transform unit 220 reconstructs the quantization coefficients by applying a quantization matrix selected among a plurality of quantization matrices with respect to the inverse quantization coefficients of two-dimensional array.

Meanwhile, different quantization matrices are applied according to the size of the current block to be reconstructed, and a quantization matrix may be selected for the blocks of the same size on the basis of at least one among the prediction mode and the intra prediction mode of the current block.

The inverse quantization/inverse transform unit 220 reconstructs a residual block by inversely transforming the reconstructed quantization coefficients, and the inverse transform process may be performed using a transform unit (TU) as a basic unit.

The adder 270 reconstructs an image block by adding the residual block reconstructed by the inverse quantization/inverse transform unit 220 and the prediction block generated by the intra prediction unit 230 or the motion compensation prediction unit 240.

The post-processing unit 250 may perform post-processing on the reconstructed image generated by the adder 270 to reduce deblocking artifacts or the like caused by image loss according to the quantization process by filtering or the like.

The picture storage unit 260 is a frame memory for storing locally decoded images on which filter post-processing has been performed by the post-processing unit 250.

The intra prediction unit 230 reconstructs the intra prediction mode of the current block on the basis of the intra prediction mode index received from the entropy decoding unit 210, and generates a prediction block according to the reconstructed intra prediction mode.

The motion compensation prediction unit 240 may generate a prediction block for the current block from a picture stored in the picture storage unit 260 on the basis of motion vector information, and when motion compensation of decimal precision is applied, the motion compensation prediction unit 240 may generate a prediction block by applying a selected interpolation filter.

The intra/inter transition switch 280 may provide the adder 270 with the prediction block generated by any one among the intra prediction unit 230 and the motion compensation prediction unit 240 on the basis of the encoding mode.

FIG. 8 is a block diagram showing an embodiment of a configuration for performing inter prediction in the image decoding apparatus 20. An inter prediction decoder includes a demultiplexer 241, a motion information encoding mode determination unit 242, a merge mode motion information decoding unit 243, an AMVP mode motion information decoding unit 244, a selection mode motion information decoding unit 248, a prediction block generation unit 245, a residual block decoding unit 246, and a reconstructed block generation unit 247.

Referring to FIG. 8, the demultiplexer 241 may demultiplex currently encoded motion information and encoded residual signals from a received bitstream, transmit the demultiplexed motion information to the motion information encoding mode determination unit 242, and transmit the demultiplexed residual signal to the residual block decoding unit 246.

The motion information encoding mode determination unit 242 may determine the motion information encoding mode of the current block, and determine that the motion information encoding mode of the current block is encoded in the skip encoding mode when skip_flag of the received bitstream has a value of 1.

When skip_flag of the received bitstream has a value of 0 and the motion information received from the demultiplexer 241 has only a merge index, the motion information encoding mode determination unit 242 may determine that the motion information encoding mode of the current block is encoded in the merge mode.

In addition, when skip_flag of the received bitstream has a value of 0 and the motion information received from the demultiplexer 241 has a reference picture index, a differential motion vector, and an AMVP index, the motion information encoding mode determination unit 242 determines that the motion information encoding mode of the current block is encoded in the AMVP mode.

The merge mode motion information decoding unit 243 may be activated when the motion information encoding mode determination unit 242 determines the motion information encoding mode of the current block as the skip or merge mode, and the AMVP mode motion information decoding unit 244 may be activated when the motion information encoding mode determination unit 242 determines the motion information encoding mode of the current block as the AMVP mode.

The selection mode motion information decoding unit 248 may decode the motion information in a prediction mode selected among the motion compensation prediction modes other than the AMVP mode, merge mode, and skip mode described above. A selective prediction mode may include a more precise motion prediction mode compared with the AMVP mode, and may be block-adaptively determined according to predetermined conditions (e.g., block size and block partition information, existence of signaling information, block position, etc.). The selective prediction mode may include, for example, at least one among a frame rate up-conversion (FRUC) mode, a bi-directional optical flow (BIO) mode, an affine motion prediction (AMP) mode, an overlapped block motion compensation (OBMC) mode, a decoder-side motion vector refinement (DMVR) mode, an alternative temporal motion vector prediction (ATMVP) mode, a spatial-temporal motion vector prediction (STMVP) mode, and a local illumination compensation (LIC) mode.

The prediction block generation unit 245 generates the prediction block of the current block using the motion information reconstructed by the merge mode motion information decoding unit 243 or the AMVP mode motion information decoding unit 244.

When the motion vector is an integer unit, the prediction block of the current block may be generated by copying a block corresponding to a position indicated by the motion vector in the picture indicated by the reference picture index.

On the other hand, when the motion vector is not an integer unit, pixels of the prediction block are generated from integer unit pixels in the picture indicated by the reference picture index. In this case, prediction pixels may be generated using an 8-tap interpolation filter for luminance pixels and a 4-tap interpolation filter for chrominance pixels.

The residual block decoding unit 246 generates a two-dimensional quantized coefficient block by entropy-decoding the residual signal and inversely scanning entropy-decoded coefficients, and the inverse scanning method may vary according to the entropy decoding method.

For example, the inverse scanning method may be applied in a raster inverse scanning method of a diagonal direction when the residual signal is decoded on the basis of CABAC, and applied in a zigzag inverse scanning method when the residual signal is decoded on the basis of CAVLC. In addition, the inverse scanning method may be determined differently according to the size of the prediction block.

The residual block decoding unit 246 may perform inverse quantization on the coefficient block generated as described above using an inverse quantization matrix, and may reconstruct a quantization parameter to derive the quantization matrix. Here, a quantization step size may be reconstructed for each coding unit having a predetermined size or larger.

The residual block decoding unit 246 reconstructs the residual block by inverse transforming the inverse-quantized coefficient block.

The reconstructed block generation unit 247 generates a reconstructed block by adding the prediction block generated by the prediction block generation unit 250 and the residual block generated by the residual block decoding unit 246.

Hereinafter, an embodiment of the process of reconstructing the current block through intra prediction will be described with reference to FIG. 7 again.

First, the intra prediction mode of the current block is decoded from the received bitstream. For this purpose, the entropy decoding unit 210 may reconstruct a first intra prediction mode index of the current block with reference to one of a plurality of intra prediction mode tables.

The intra prediction mode tables are tables shared by the encoding apparatus 10 and the decoding apparatus 20, and any one table selected according to distribution of intra prediction modes for a plurality of blocks adjacent to the current block may be applied.

For example, when the intra prediction mode of the left block of the current block is the same as the intra prediction mode of the upper block of the current block, the first intra prediction mode index of the current block is reconstructed by applying a first intra prediction mode table, and otherwise, the first intra prediction mode index of the current block may be reconstructed by applying a second intra prediction mode table.

As another example, in the case where both the intra prediction modes of the upper block and the left block of the current block are directional intra prediction modes, when the direction of the intra prediction mode of the upper block and the direction of the intra prediction mode of the left block are within a predetermined angle, the first intra prediction mode index of the current block may be reconstructed by applying the first intra prediction mode table, and when the directions are out of the predetermined angle, the first intra prediction mode index of the current block may be reconstructed by applying the second intra prediction mode table.

The entropy decoding unit 210 transmits the first intra prediction mode index of the reconstructed current block to the intra prediction unit 230.

The intra prediction unit 230 receiving the first intra prediction mode index may determine the most probable mode of the current block as the intra prediction mode of the current block when the index has a minimum value (i.e., 0).

Meanwhile, when the index has a value other than 0, the intra prediction unit 230 compares the index indicated by the most probable mode of the current block with the first intra prediction mode index, and when the first intra prediction mode index is not smaller than the index indicated by the most probable mode of the current block as a result of the comparison, an intra prediction mode corresponding to a second intra prediction mode index obtained by adding 1 to the first intra prediction mode index may be determined as the intra prediction mode of the current block, and otherwise, an intra prediction mode corresponding to the first intra prediction mode index may be determined as the intra prediction mode of the current block.

The intra prediction mode that can be allowed for the current block may configured of at least one non-directional mode and a plurality of directional modes.

The one or more non-directional modes may be a DC mode and/or a planar mode. In addition, any one among the DC mode and the planar mode may be adaptively included in the allowable intra prediction mode set.

To this end, information specifying the non-directional mode included in the allowable intra prediction mode set may be included in the picture header or the slice header.

Next, the intra prediction unit 230 reads reference pixels from the picture storage unit 260 to generate an intra prediction block, and determines whether there exists unavailable reference pixels.

The determination may be performed according to whether there exist reference pixels used to generate an intra prediction block by applying the decoded intra prediction mode of the current block.

Next, when it needs to generate reference pixels, the intra prediction unit 230 may generate the reference pixels at unavailable locations using previously reconstructed available reference pixels.

Although the method of defining unavailable reference pixels and generating reference pixels may be the same as the operation of the intra prediction unit 150 according to FIG. 1, reference pixels used for generating an intra prediction block may be selectively reconstructed according to the decoded intra prediction mode of the current block.

In addition, the intra prediction unit 230 determines whether or not to apply a filter to the reference pixels to generate a prediction block, i.e., whether or not to apply filtering to the reference pixels to generate an intra prediction block of the current block may be determined on the basis of the decoded intra prediction mode and the size of the current prediction block.

Since the problem of blocking artifacts increases as the size of the block increases, the number of prediction modes for filtering the reference pixels may be increased as the size of the block increases. However, when a block is larger than a predetermined size, it may be regarded as a flat area, and thus the reference pixels may not be filtered to reduce complexity.

When it is determined that a filter needs to be applied to the reference pixels, the intra prediction unit 230 filters the reference pixels using the filter.

At least two or more filters may be adaptively applied according to the degree of difference in steps between the reference pixels. Preferably, filter coefficients of the filter are symmetrical.

In addition, the two or more filters described above may be adaptively applied according to the size of the current block, and when the filters are applied, a filter having a narrow bandwidth may be applied to the blocks of a small size, and a filter having a wide bandwidth may be applied to the blocks of a large size.

A filter does not need to be applied in the case of DC mode since the prediction block is generated using an average value of the reference pixels. A filter does not need to be applied to the reference pixels in the vertical mode in which there is a correlation in the vertical direction, and a filter does not need to be applied to the reference pixel even in the horizontal mode in which images have a correlation in the horizontal direction.

As described above, since whether or not to apply filtering also has a correlation with the intra prediction mode of the current block, reference pixels may be adaptively filtered on the basis of the intra prediction mode of the current block and the size of the prediction block.

Next, the intra prediction unit 230 generates a prediction block using the reference pixels or the filtered reference pixels according to the reconstructed intra prediction mode, and since generation of the prediction block is the same as the operation in the encoding apparatus 10, detailed description thereof will be omitted.

The intra prediction unit 230 determines whether or not to filter the generated prediction block, and whether or not to filter may be determined using the information included in the slice header or the coding unit header or according to the intra prediction mode of the current block.

When it is determined to filter the generated prediction block, the intra prediction unit 230 may generate a new pixel by filtering a pixel at a specific location in the generated prediction block using available reference pixels adjacent to the current block.

For example, in the DC mode, prediction pixels in contact with the reference pixels among the prediction pixels may be filtered using the reference pixels in contact with the prediction pixels.

Accordingly, the prediction pixel is filtered using one or two reference pixels according to the location of the prediction pixel, and filtering of the prediction pixel in the DC mode may be applied to prediction blocks of all sizes.

On the other hand, in the vertical mode, prediction pixels in contact with the left reference pixel, among the prediction pixels of the prediction block, may be changed using reference pixels other than the upper pixels used for generating the prediction block.

In the same way, in the horizontal mode, prediction pixels in contact with the upper reference pixel, among the generated prediction pixels, may be changed using reference pixels other than the left pixels used for generating the prediction block.

The current block may be reconstructed using the prediction block of the current block reconstructed in this way and the residual block of the decoded current block.

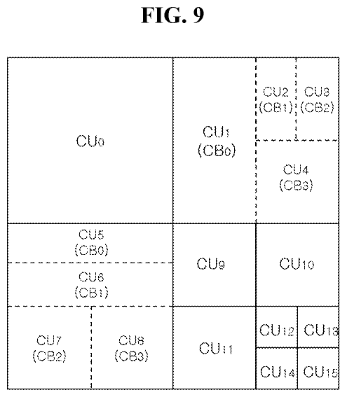

FIG. 9 is a view for explaining a second embodiment of a method of partitioning and processing an image in units of blocks.

Referring to FIG. 9, a coding tree unit (CTU) having a maximum pixel size of 256×256 may be partitioned in a quad tree structure first, and then partitioned into four coding units (CUs) having a square shape.

Here, at least one of the coding units partitioned in a quad tree structure may be partitioned in a binary tree structure to be partitioned again into two coding units (CUs) having a rectangular shape.

On the other hand, at least one of the coding units partitioned in a quad tree structure may be partitioned in a quad tree structure to be partitioned again into four coding units (CUs) having a square shape.

In addition, at least one of the coding units partitioned again in a binary tree structure may be partitioned in a binary tree structure to be partitioned into two coding units (CUs) having a square or rectangular shape.

On the other hand, at least one of the coding units partitioned again in a quad tree structure may be partitioned again in a quad tree structure or a binary tree structure to be partitioned into coding units (CUs) having a square or rectangular shape.

The CUs configured by being partitioned in a binary tree structure as described above are not partitioned anymore and may be used for prediction and transform. At this point, the binary-partitioned CU may include a coding block (CB), which is a block unit that actually performs encoding/decoding, and a syntax corresponding to the coding block. That is, the sizes of the prediction unit (PU) and the transform unit (TU) belonging to the coding block (CB) as shown in FIG. 9 may be the same as the size of the corresponding coding block (CB).

The coding unit partitioned in a quad tree structure as described above may be partitioned into one or two or more prediction units (PUs) using the method described above with reference to FIGS. 3 and 4.

In addition, the coding unit partitioned in a quad tree structure as described above may be partitioned into one or two or more transform units (TUs) using the method described above with reference to FIG. 5, and the partitioned transform units (TUs) may have a maximum pixel size of 64×64.

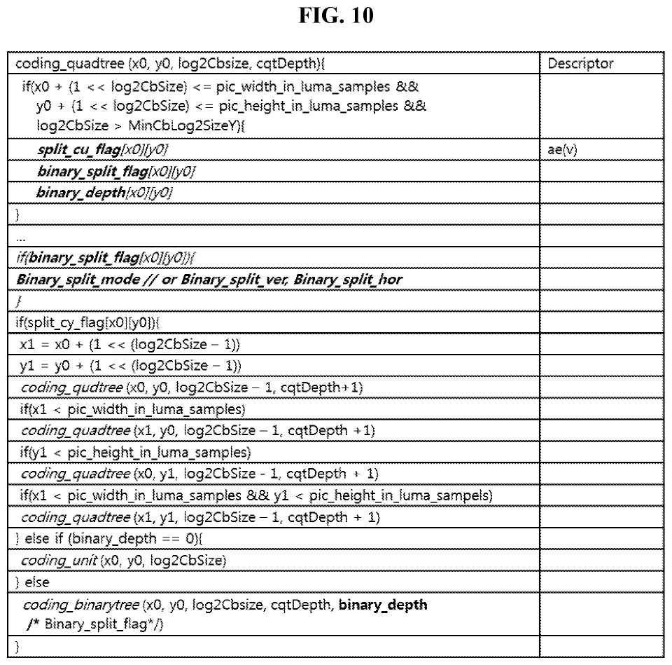

FIG. 10 is a view showing an embodiment of a syntax structure used to divide and process an image in units of blocks.

Referring to FIGS. 10 and 9, a block structure according to an embodiment of the present invention may be determined through split_cu_flag indicating whether a coding unit is partitioned in a quad tree and binary_split_flag indicating whether a coding unit is partitioned in a binary tree.

For example, whether or not a coding unit (CU) is partitioned as described above may be indicated using split_cu_flag. In addition, binary_split_flag indicating whether or not binary partition is performed and a syntax indicating a partition direction may be determined in correspondence to the binary-partitioned CU after quad tree partition. At this point, as a method of indicating the directionality of binary partition, a method of decoding a plurality of syntaxes such as binary_split_hor and binary_split_ver and determining a partition direction based on the syntaxes, or a method of decoding one syntax such as binary_split_mode and a signal value corresponding thereto and processing the partition in the horizontal (0) or vertical (1) direction may be exemplified.

As another embodiment according to the present invention, the depth of a coding unit (CU) partitioned using a binary tree may be expressed using binary_depth.

Encoding and decoding of an image may be performed by applying the methods described above with reference to FIGS. 1 to 8 to the blocks (e.g., coding unit (CU), prediction unit (PU), and transform unit (TU)) partitioned by the methods described with reference to FIGS. 9 and 10.

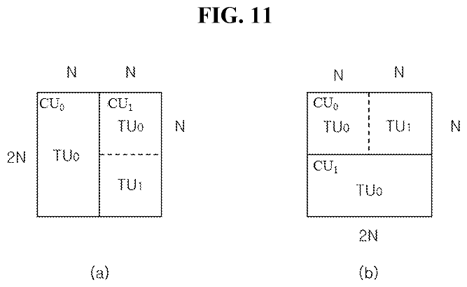

Hereinafter, still another embodiment of a method of partitioning a coding unit (CU) into one or two or more transform units (TUs) will be described with reference to FIGS. 11 to 16.

According to an embodiment of the present invention, a coding unit (CU) may be partitioned in a binary tree structure to be partitioned into transform units (TUs), which are basic units for performing transform on a residual block.

For example, referring to FIG. 11, at least one of the rectangular coding blocks (CU0 and CU1) partitioned in a binary tree structure to have a size of N×2N or 2N×N is partitioned again in a binary tree structure to be partitioned into square transform units (TU0 and TU1) having a size of N×N.

As described above, the block-based image encoding method may perform the steps of prediction, transform, quantization, and entropy encoding.

At the prediction step, a prediction signal is generated with reference to a block currently being encoded together with an existing encoded image or a neighboring image, and a differential signal with respect to the current block may be calculated through the prediction signal.

On the other hand, at the transform step, transform is performed using various transform functions using the differential signal as an input, and the transformed signal is classified into DC coefficients and AC coefficients, and energy compaction is achieved to improve encoding efficiency.

In addition, at the quantization step, quantization is performed using transform coefficients as an input, and then an image may be encoded as entropy encoding is performed on the quantized signal.

Meanwhile, the image decoding method is performed in the reverse order of the encoding process described above, and image quality distortion phenomenon may occur at the quantization step.

As a method of reducing image quality distortion phenomenon while improving encoding efficiency, the size or shape of the transform unit (TU) and the type of applied transform functions may be diversified according to distribution of the differential signal and the characteristics of an image received as an input at the transform step.

For example, when a block similar to the current block is found at the prediction step through a block-based motion estimation process, distribution of the differential signal may occur in various forms according to the characteristics of the image using a cost measurement method such as the sum of absolute difference (SAD) or the mean square error (MSE).

Accordingly, effective encoding may be performed by selectively determining the size or shape of the transform unit (CU→TU) and performing transform on the basis of the distribution of various differential signals.

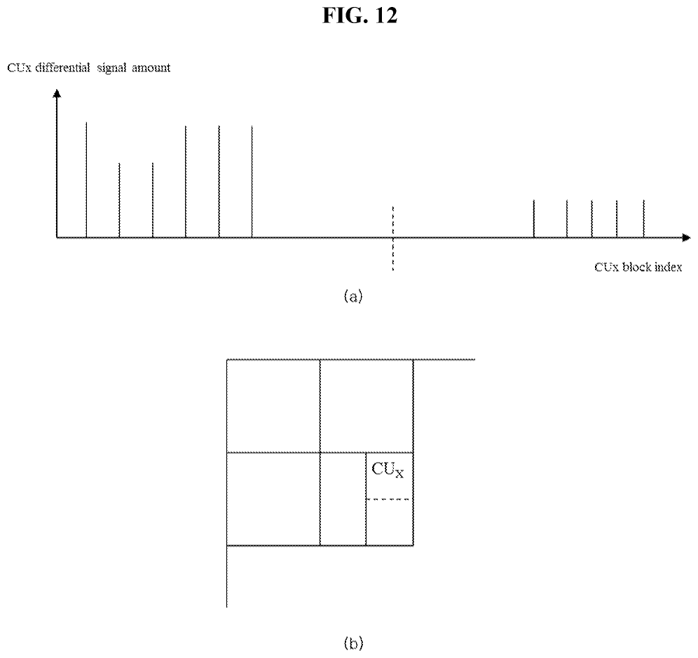

Referring to FIG. 12, when a differential signal is generated as shown in FIG. 12(a) in an arbitrary coding unit (CUx), as the coding unit (CUx) is partitioned in a binary tree structure as shown in FIG. 12(b) to be partitioned into two transform units (TUs), efficient transform may be performed.

For example, since it can be said that a DC value generally means an average value of input signals, when a differential signal as shown in FIG. 12(a) is received as an input of the transform process, the DC value may be expressed effectively by partitioning the coding unit (CUx) into two transform units (TUs).

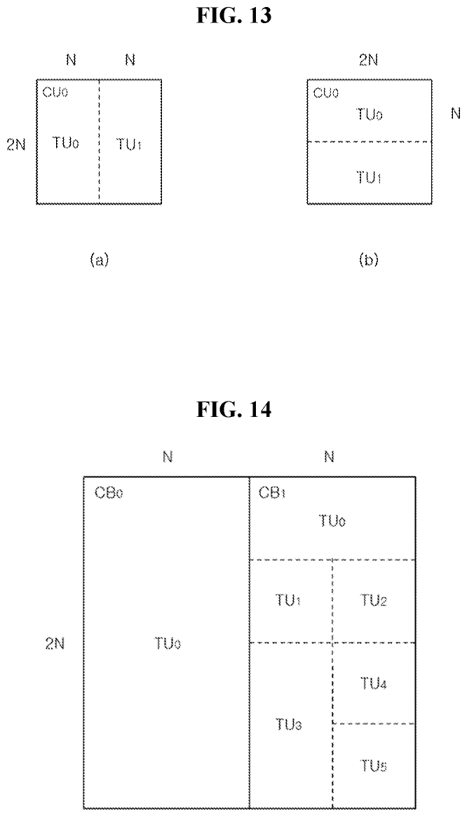

Referring to FIG. 13, a square coding unit (CU0) having a size of 2N×2N is partitioned in a binary tree structure to be partitioned into rectangular transform units (TU0 and TU1) having a size of N×2N or 2N×N.

According to another embodiment of the present invention, the coding unit (CU) may be partitioned into a plurality of transform units (TUs) by repeating the step of partitioning the coding unit (CU) in a binary tree structure two or more times as described above.

Referring to FIG. 14, a rectangular coding block (CB1) having a size of N×2N is partitioned in a binary tree structure, and after constructing a rectangular block having a size of N/2×N or N×N/2 by partitioning the partitioned block having a size of N×N in a binary tree structure again, the block having a size of N/2×N or N×N/2 may be partitioned in a binary tree structure again to be partitioned into square transform units (TU1, TU2, TU4, and TU5) having a size of N/2×N/6b 2.

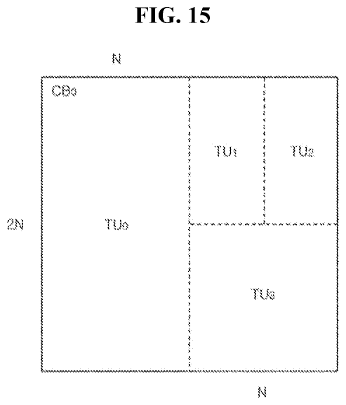

Referring to FIG. 15, a square coding block (CU0) having a size of 2N×2N is partitioned in a binary tree structure, and after constructing a square block having a size of N×N by partitioning the partitioned block having a size of N×2N in a binary tree structure again, the block having a size of N/N may be partitioned in a binary tree structure again to be partitioned into rectangular transform units (TU1 and TU2) having a size of N/2×N.

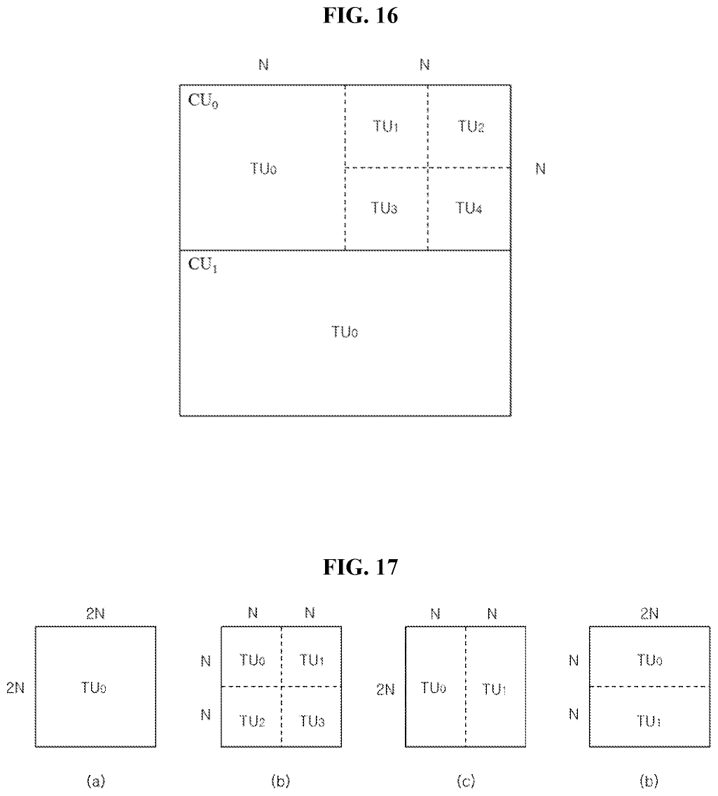

Referring to FIG. 16, a rectangular coding block (CU0) having a size of 2N×N is partitioned in a binary tree structure, and the partitioned block having a size of N×N may be partitioned in a quad tree structure again to be partitioned into square transform units (TU1, TU2, TU3, and TU4) having a size of N/2×N/2.

Encoding and decoding of an image may be performed by applying the methods described above with reference to FIGS. 1 to 8 to the blocks (e.g., coding unit (CU), prediction unit (PU), and transform unit (TU)) partitioned by the methods described with reference to FIGS. 11 and 16.

Hereinafter, embodiments of a method of determining a block partition structure by the encoding apparatus 10 according to the present invention will be described.

The picture partition unit 110 included in the image encoding apparatus 10 may determine a partition structure of a coding unit (CU), a prediction unit (PU), and a transform unit (TU) that can be partitioned as described above by performing Rate Distortion Optimization (RDO) in an order set in advance.

For example, in order to determine a block partition structure, the picture partition unit 110 may determine an optimal block partition structure from the aspect of bitrate and distortion while performing Rate Distortion Optimization-Quantization (RDO-Q).

Referring to FIG. 17, when a coding unit (CU) has a form of a 2N×2N pixel size, an optimal partition structure of the transform unit (TU) may be determined by performing RDO in order of the transform unit (TU) partition structure of a pixel size of 2N×2N shown in (a), a pixel size of N×N shown in (b), a pixel size of N×2shown in (c), and a pixel size of 2N×N shown in (d).

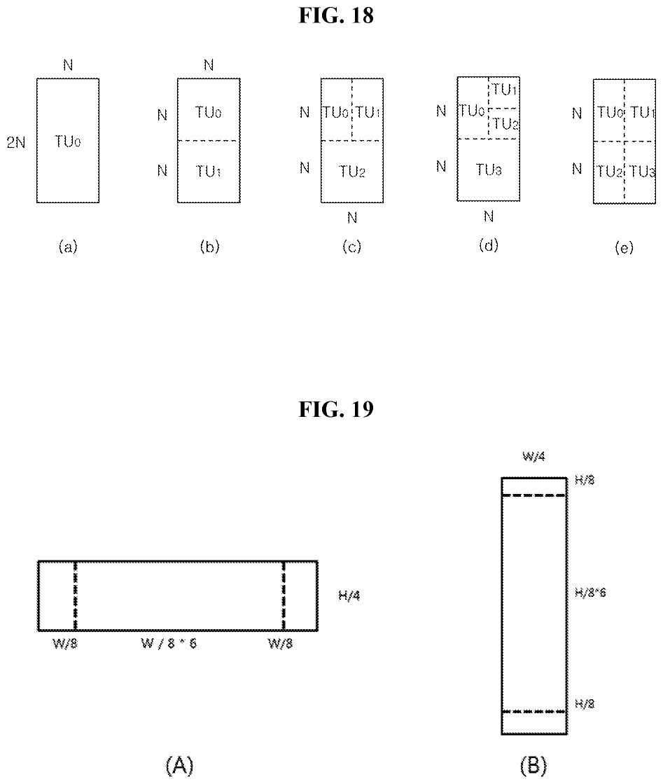

Referring to FIG. 18, when a coding unit (CU) has a form of an N×2N or 2N×N pixel size, an optimal partition structure of the transform unit (TU) may be determined by performing RDO in order of the transform unit (TU) partition structure of a pixel size of N×2N (or 2N×N) shown in (a), a pixel size of N×N shown in (b), pixel sizes of N/2×N (or N×N/2) and N×N shown in (c), pixel sizes of N/2×N/2, N/2×N and N×N shown in (d), and a pixel size of N/2×N shown in (e).

In the above description, although the block partition methods of the present invention have been described through an example of determining a block partition structure by performing Rate Distortion Optimization (RDO), as the picture partition unit 110 determines the block partition structure using the sum of absolute difference (SAD) or the mean square error (MSE), proper efficiency can be maintained while reducing complexity.

According to an embodiment of the present invention, whether or not to apply the adaptive loop filtering (ALF) may be determined in units of coding units (CUs), prediction units (PUs), or transform units (TUs) partitioned as described above.

For example, whether or not to apply the adaptive loop filtering (ALF) may be determined in units of coding units (CUs), and the size or coefficients of a loop filter to be applied may vary according to the coding unit (CU).

In this case, information indicating whether or not the adaptive loop filtering (ALF) is applied to each coding unit (CU) may be included in each slice header.

In the case of a chrominance signal, whether or not to apply the adaptive loop filtering (ALF) may be determined in units of pictures, and the shape of a loop filter may also be a rectangular shape unlike the luminance.

In addition, whether or not to apply the adaptive loop filtering (ALF) may be determined for each slice. Accordingly, information indicating whether or not the adaptive loop filtering (ALF) is applied to the current slice may be included in the slice header or the picture header.

When it is indicated that adaptive loop filtering is applied to the current slice, the slice header or the picture header may additionally include information indicating the horizontal and/or vertical direction filter length of the luminance component used in the adaptive loop filtering process.

The slice header or the picture header may include information indicating the number of filter sets, and when the number of filter sets is two or more, filter coefficients may be encoded in a prediction method.

Accordingly, the slice header or the picture header may include information indicating whether or not the filter coefficients are encoded in a prediction method, and may include predicted filter coefficients when the prediction method is used.

Meanwhile, chrominance components, as well as luminance, may be adaptively filtered. In this case, information indicating whether or not each chrominance component is filtered may be included in the slice header or the picture header, and in order to reduce the number of bits, joint coding (i.e., multiplex coding) may be performed together with information indicating whether or not filtering is performed on Cr and Cb.

At this point, since it is most likely that neither Cr nor Cb is filtered to reduce complexity in the case of chrominance components, when neither Cr nor Cb is filtered, entropy encoding is performed by allocating the smallest index.

In addition, when both Cr and Cb are filtered, entropy encoding may be performed by allocating the largest index.

FIGS. 19 to 29 are views for explaining a composite partition structure according to another embodiment of the present invention.

For example, referring to FIG. 19, as the coding unit (CU) is partitioned in a binary tree structure, the coding unit (CU) is partitioned in the form of a rectangle of which the horizontal length W is longer than the vertical length H as shown in FIG. 19(A) and a rectangle of which the vertical length H is longer than the horizontal length W as shown in FIG. 19(B). As described, in the case of a coding unit that is long in a specific direction, it is highly probable that the coding information is relatively concentrated in the left and right or upper and lower boundary areas compared to the central area.

Accordingly, for the sake of more precise and efficient encoding and decoding, the encoding apparatus 10 according to an embodiment of the present invention may divide a coding unit in a ternary tree or triple tree structure capable of easily partitioning an edge area or the like of a coding unit partitioned to have a long specific direction length by means of quad tree and binary tree partition.

For example, FIG. 19(A) shows that when a partition target coding unit is a horizontally partitioned coding unit, the coding unit may be ternarily partitioned into a first area on the leftmost side to have a horizontal length of W/8 and a vertical length of H/4, a second area in the middle to have a horizontal length of W/8*6 and a vertical length of H/4, and a third area on the rightmost side to have a horizontal length of W/8 and a vertical length of H/4.

In addition, FIG. 19(B) shows that when a partition target coding unit is a vertically partitioned coding unit, the coding unit may be partitioned into a first area on the uppermost side to have a horizontal length of W/4 and a vertical length of H/8, a second area in the middle to have a horizontal length of W/4 and a vertical length of H/8*6, and a third area on the lowermost side to have a horizontal length of W/4 and a vertical length of H/48.

In addition, the encoding apparatus 10 according to an embodiment of the present invention may perform partition of the ternary tree structure through the picture partition unit 110. To this end, the picture partition unit 110 may determine partition into the quad tree and binary tree structures described above according to encoding efficiency, and may finely determine a subdivided partition method also in consideration of the ternary tree structure.

Here, partition of the ternary tree structure may be performed for all coding units without special limitation. However, considering the encoding and decoding efficiency as described above, it may be desirable to allow the ternary tree structure only for coding units of a specific condition.

In addition, although the ternary tree structure may require various types of ternary partition for the coding tree unit, it may be desirable to allow only a predetermined optimized form in consideration of encoding and decoding complexity and transmission bandwidth of signaling.

Accordingly, in determining partition of the current coding unit, the picture partition unit 110 may determine and decide whether or not to divide the current coding unit in a ternary tree structure of a specific form only when the current coding unit is meets a preset condition. In addition, as the ternary tree like this is allowed, the partition ratio of the binary tree may be expanded and changed to 3:1, 1:3, or the like, rather than only 1:1. Accordingly, the partition structure of a coding unit according to an embodiment of the present invention may include a composite tree structure subdivided into a quad tree, a binary tree, or a ternary tree according to the ratio.

For example, the picture partition unit 110 may determine a composite partition structure of a partition target coding unit on the basis of the partition table described above.

According to an embodiment of the present invention, the picture partition unit 110 may process quad tree partition in correspondence to the maximum size of a block (e.g., 128×128, 256×256, etc. based on pixel) and perform a composite partition process of processing at least one among a double tree structure and triple tree structure partition corresponding to the terminal node partitioned into a quad tree.

Particularly, according to an embodiment of the present invention, the picture partition unit 110 may determine any one partition structure among a first binary partition (BINARY 1) and a second binary partition (BINARY 2) that are binary tree partition and a first ternary partition (TRI 1) and a second ternary partition (TRI 2) that are ternary tree partition corresponding to the characteristics and size of the current block, according to the partition table.

Here, the first binary partition may correspond to vertical or horizontal partition having a ratio of N:N, and the second binary partition may correspond to vertical or horizontal partition having a ratio of 3N:N or N:3N, and each binary-partitioned root CU may be partitioned into CU0 and CU1, each having a size specified in the partition table.

Here, the first ternary partition may correspond to vertical or horizontal partition having a ratio of N:2N:N, and the second ternary partition may correspond to vertical or horizontal partition having a ratio of N:6N:N, and each ternary-partitioned root CU may be partitioned into CU0, CU1 and CU2, each having a size specified in the partition table.

However, the picture partition unit 110 according to an embodiment of the present invention may individually set a maximum coding unit size and a minimum coding unit size for applying the first binary partition, the second binary partition, the first ternary partition, or the second ternary partition.

This is since that it may be inefficient, from the aspect of complexity, to perform encoding and decoding processing corresponding to a block having a minimum size, e.g., a horizontal or vertical pixel size of 2 or less, and therefore, the partition table according to an embodiment of the present invention may define in advance an allowable partition structure for the size of each coding unit.

Accordingly, the picture partition unit 110 may prevent in advance a case of partitioning a coding unit to have a horizontal or vertical pixel size of 2 as a minimum size, e.g., a size smaller than 4, and to this end, whether or not to allow the first binary partition, the second binary partition, the first ternary partition, or the second ternary partition may be determined in advance from the size of a partition target block, and an optimal partition structure may be determined by processing and comparing RDO performance operations corresponding to the allowable partition structure.

For example, when the root coding unit (CU0) of a maximum size is binary-partitioned, the binary partition structure may be partitioned into CU0 and CU1 configuring any one vertical partition structure of 1:1, 3:1, or 1:3, and the ternary partition structure may be partitioned into CU0, CU1, and CU2 configuring any one vertical partition structure of 1:2:1 or 1:6:1.

An allowable vertical partition structure may be restrictively determined according to the size of the partition target coding unit. For example, although all of the first binary partition, the second binary partition, the first ternary partition, and the second ternary partition may be allowed for the vertical partition structure of a 64×64 coding unit and a 32×32 coding unit, the second ternary partition may be restricted as being impossible in the vertical partition structure of a 16×16 coding unit. In addition, only the first binary partition may be restrictively allowed in the vertical partition structure of a 8×8 coding unit. Accordingly, partition into blocks smaller than a minimum size, which generates complexity, may be prevented in advance.

In the same way, when the root coding unit (CU0) of a maximum size is binary-partitioned, the binary partition structure may be partitioned into CU0 and CU1 configuring any one horizontal partition structure of 1:1, 3:1, or 1:3, and the ternary partition structure may be partitioned into CU0, CU1, and CU2 configuring any one horizontal partition structure of 1:2:1 or 1:6:1.

An allowable horizontal partition structure may be restrictively determined according to the size of the partition target coding unit. For example, although all of the first binary partition, the second binary partition, the first ternary partition, and the second ternary partition may be allowed for the horizontal partition structure of a 64×64 coding unit and a 32×32 coding unit, the second ternary partition may be restricted as being impossible in the horizontal partition structure of a 16x16 coding unit. In addition, only the first binary partition may be restrictively allowed in the horizontal partition structure of a 8×8 coding unit. Accordingly, partition into blocks smaller than a minimum size, which generates complexity, may be prevented in advance.

On the other hand, the picture partition unit 110 may horizontally divide the vertically partitioned coding unit into a first binary partition or a second binary partition, or horizontally divide the vertically partitioned coding unit into a first ternary partition or a second ternary partition, according to the partition table.

For example, in correspondence to a coding unit vertically partitioned into 32×64, the picture partition unit 110 may divide the coding unit into CU0 and CU1 of 32×32 according to the first binary partition, CU0 and CU1 of 32×48 and 32×16 according to the second binary partition, CU0, CU1, and CU2 of 32×32, 32×16, and 32×16 according to the first ternary partition, or CU0, CU1, and CU2 of 32×8, 64×48, and 32×8 according to the second ternary partition.

In addition, the picture partition unit 110 may vertically divide the horizontally partitioned coding unit into a first binary partition or a second binary partition, or vertically divide the horizontally partitioned coding unit into a first ternary partition or a second ternary partition.

For example, in correspondence to a coding unit horizontally partitioned into 32×16, the picture partition unit 110 may divide the coding unit into CU0 and CU1 of 16×16 according to the first binary partition, CU0 and CU1 of 24×16 and 8×16 according to the second binary partition, CU0, CUL and CU2 of 8×16, 16×16, and 8×16 according to the first ternary partition, or CU0, CUL and CU2 of 4×16, 24×16, and 4×16 according to the second ternary partition.

The structure that allows partition may be conditionally determined to be different for each CTU size, CTU group unit, slice unit, and vertical and horizontal directions, and therefore, information on each CU partition ratio and determination size in the case of processing the first binary partition, the second binary partition, the first ternary partition, and the second ternary partition may be defined by the partition table, or information on the condition may be set in advance.

On the other hand, the partition target coding unit may be partitioned in equal horizontal or vertical partition. However, the equal partition may be a very inefficient prediction method when an area concentrated with high prediction values exists only in some boundary areas. Accordingly, the picture partition unit 110 according to an embodiment of the present invention may conditionally allow unequal partition, in which a coding unit is unequally partitioned according to a predetermined ratio as shown in FIG. 18(C).

For example, when binary equal partition is Binary of 1:1, the ratio of unequal partition may be determined as Asymmetric Binary of (⅓, ⅔), (¼, ¾), (⅖, ⅗), (⅜, ⅝), and (⅕, ⅘). For example, when the ternary equal partition is 1:2:1, the ratio of unequal partition may be variably determined as 1:6:1 or the like.

Meanwhile, the picture partition unit 110 according to an embodiment of the present invention may basically divide a picture into a plurality of coding tree units (CTUs) including coding units that are prediction units. A plurality of coding tree units may configure a tile unit or a slice unit. For example, one picture may be partitioned into a plurality of tiles that are rectangular areas, and the picture may be partitioned into tiles partitioned into one or more vertical columns, partitioned into tiles partitioned into one or more horizontal columns, or partitioned into tiles partitioned into one or more vertical columns and horizontal columns. The picture may be equally partitioned into tiles of the same size on the basis of the lengths of horizontal and vertical columns within the picture, or may be partitioned into tiles of different sizes.

Generally, according to standard syntax such as HEVC or the like, in the case of an area partitioned into tiles or slices, high-level syntax may be allocated and encoded as header information to process the tiles or slices to be independent from the other tiles or slices. Owing to the high-level syntax, parallel processing for each tile or slice may be possible.

However, there is a problem in that the current tile or slice encoding method only depends on encoding conditions in the encoding apparatus, and the performance and environment of the decoding apparatus are not considered. For example, although the number of cores or threads of the decoding apparatus is greater than that of the encoding apparatus, a problem that the performance cannot be utilized may occur.

Particularly, with respect to the current image that requires partial decoding processing based on ultrahigh resolution and user perspective tracking, such as 360-degree virtual reality image or the like that emerges recently, there is a problem in that the one-sided partition structure and header determination process is dependent on the encoding apparatus, and as a result, the overall encoding and decoding performance is lowered.

According to an embodiment of the present invention for solving this problem, the picture partition unit 110 may divide a plurality of tiles that divides a picture as described above into independent tiles or dependent tiles determined within each tile or tile group, and may configure header information corresponding thereto by allocating attribute information of each tile, which can be encoded and decoded to be independent from or dependent on the other tiles.

Furthermore, the picture partition unit 110 according to an embodiment of the present invention may divide the picture into a tile group or subpicture formed by continuously arranging a plurality of tiles according to the positions and properties of the tiles, and encode configuration information corresponding to each subpicture included in each tile group or subpicture set and transmits the configuration information to the decoding apparatus 20 so that tiles corresponding to a tile group or tiles included in a subpicture may be independently or dependently processed.

Accordingly, the tile group or subpicture is not limited by their names, and the practical meaning is formed by partitioning the picture and may indicate one or more rectangular areas that can be configured as a tile or a slice. Accordingly, although a partition area according to an embodiment of the present invention is mainly described as a name referred to as a tile group, it is a rectangular area partitioning the picture and may be referred to as a subpicture area including one or more tiles or slices. Independent or dependent processing of each subpicture may be determined according to signaling of configuration information for a subpicture set including the subpictures. Accordingly, the technical configuration corresponding to the tile group described below may be equally applied to the subpicture.

Here, the term independent may mean that encoding and decoding processes including intra prediction, inter prediction, transform, quantization, entropy encoding and decoding, and filtering may be performed as an independent picture regardless of partitioned other tiles, tile groups, or subpictures. However, this does not mean that all encoding and decoding processes are completely independently performed for each tile, and encoding and decoding may be selectively performed using information on other tiles when inter prediction or in-loop filtering is performed.

In addition, dependence may mean a case in which encoding or decoding information of another tile is required in the encoding and decoding processes including intra prediction, inter prediction, transform, quantization, entropy encoding and decoding, and filtering. However, this does not mean that all encoding and decoding processes are completely dependently performed on each tile, and independent encoding and decoding may be performed in some processes.

In addition, as described above, the tile group may indicate a specific area in the picture formed by continuously arranging the tiles, and the picture partition unit 110 according to an embodiment of the present invention may configure a tile group and generate tile group information according to an encoding condition, and the tile group information may make it possible to perform a more efficient parallel decoding process according to the environment and performance of the decoding apparatus 20.

In addition, as described above, the tile group may correspond to a subpicture obtained by partitioning a picture, and in this case, the tile group information may include information on the subpicture set configuration corresponding to a subpicture or a subpicture set.

In this regard, first, tile group information processed and determined by the picture partition unit 110 will be described.

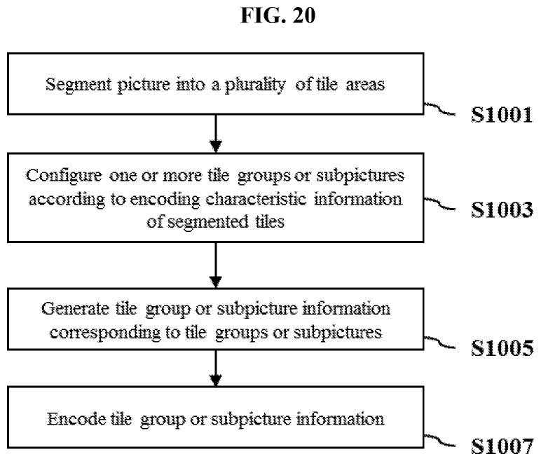

FIG. 20 is a flowchart illustrating the process of encoding tile group information according to an embodiment of the present invention.

Referring to FIG. 20, the encoding apparatus 10 according to an embodiment of the present invention divides a picture into a plurality of tile areas through the picture partition unit 110 (S1001), and may configure one or more tile groups or subpictures according to the encoding characteristic information of the partitioned tiles (S1003).

Then, the encoding apparatus 10 may generate tile group information or subpicture information corresponding to each tile group through the picture partition unit 110 (S1005), encode the generated tile group information or subpicture information (S1007), and transfer the encoded tile group information or subpicture information to the decoding apparatus 20.

Here, header information of each tile group or subpicture may be exemplified as the tile group information or subpicture information, and the header information may be included in the picture header information of an encoded image bitstream in the form of high-level syntax. In addition, the header information is another form of high-level syntax that can be transmitted to be included in a supplemental enhancement information (SEI) message of the encoded image bitstream.

More specifically, the tile group or subpicture information according to an embodiment of the present invention may include identification information of each tile group or subpicture, and each tile group or subpicture may include image configuration information that makes it possible to efficiently perform a partial and independent parallel decoding process.

For example, each of the tile groups (or subpictures) corresponds to a user perspective, corresponds to a projection direction of a 360-degree image, or may be configured according to a specific arrangement, and accordingly, as the tile group (or subpicture) information includes characteristic information of each tile group, decoding or reference priority information corresponding to the tiles included in the tile group, or information on whether or not a process including parallelization is possible, the decoding apparatus 20 makes a variable and efficient image decoding process possible.

In addition, information on the tile group or subpicture may be updated according to a group of picture (GOP) unit to which each picture belongs, and to this end, the tile group information may be configured or initialized according to the cycle of a network abstraction layer (NAL) unit.

In addition, level information may be suggested as specific tile group (or subpicture) information according to an embodiment of the present invention. The level information may indicate encoding dependency or independency between tiles or slices in each tile group (or subpicture) and those of another tile group (or subpicture), and may be used for determining processing conformance in the decoding apparatus 20 in correspondence to a value assigned according to the level information. That is, as described above, the decoding apparatus 20 may perform a bitstream processing conformance test process including a parallelization step for each tile group or subpicture according to performance and environment, and according to the level information, processing conformance may be determined for each layer of the tile groups (or subpictures) included in the bitstream.

In addition, for example, the number of tiles included in a tile group (or subpicture set), CPB size, bit rate, and presence of independent tiles (or independent subpictures) in a tile group (or subpicture set), whether all the tiles are independent tiles, or whether all the tiles are dependent tiles may be indicated by the level information.

For example, in the case of a 360-degree virtual reality image, a high-level level information may be determined in correspondence to a tile group or subpicture set corresponding to a user view port that requires high-quality decoding according to the intention of an image manufacturer or a content provider, and first level information may be allocated to the high-level tile groups or subpictures. In this case, according to the performance and environment, the decoding apparatus 20 may test processing conformance corresponding to the first level information of the tile group (subpicture), allocate performance of a possible maximum value, and independently perform parallel processing on each tile or subpicture in a corresponding tile group or subpicture set.

In addition, second group level information may be allocated to a tile group having a level relatively lower than the level of the first group. In this case, the decoding apparatus 20 may perform a process having intermediate performance by testing processing conformance corresponding to the level information of the tile group (subpicture), preferentially processing tiles specified as independent tiles in parallel as much as possible, and processing remaining dependent tiles, according to performance and environment. Here, the independent tile preferentially processed in parallel may be a first tile among the tiles included in the tile group, and the remaining tiles may be dependent tiles of which the encoding and decoding process is dependent on the first tile.

Meanwhile, third group level information may be allocated to a tile group having a level lower than the second group level. In this case, the decoding apparatus 20 may test processing conformance corresponding to the level information of the tile group (subpicture), and perform a decoding process on the dependent tiles in the current tile group using tile decoding information processed in another tile group.

Meanwhile, the level information according to an embodiment of the present invention may include parallelization layer information indicating possibility of parallelization processing of tiles or subpictures in a tile group or subpicture set. The parallelization layer information may include maximum or minimum parallelization layer unit information indicating a level capable of processing tiles or subpictures in each tile group or subpicture in parallel.

Accordingly, the parallelization layer unit information may indicate that tiles in the tile group are partitioned into parallelization layers as much as a level corresponding to the parallelization layer unit information to be configured as a tile group (subpicture) and independently processed in parallel.

For example, the parallelization layer partitioned as much as a level corresponding to the parallelization layer unit information may include at least one independent tile that is non-dependent, and the decoding apparatus 20 may variably determine whether or not to perform parallel decoding on the tiles in an encoded tile group through a parallelization determination process on the basis of the parallelization layer information.

Here, the parallelization determination process may include a process of determining a parallelization level of each tile group on the basis of the level information, the parallelization layer information, and the environment variable of the decoding apparatus, and the environment variable may be determined according to at least one among a system environment variable, a network variable, and a perspective variable of the decoding apparatus 20.

Accordingly, the decoding apparatus 20 may perform an efficient pre-decoding setting on the basis of the environment variable according to its own conformance determination process in the decoding apparatus 20 based on tile group or subpicture level information, and perform optimized partial decoding and parallel decoding processing based thereon. Particularly, this improves overall encoding and decoding performance corresponding to an ultrahigh-resolution merged image for each user perspective, such as a 360-degree image.

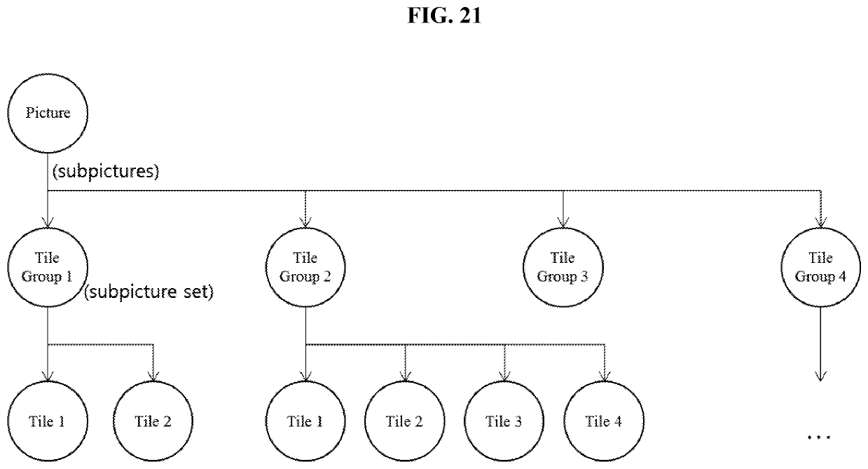

FIGS. 21 to 25 are views for explaining a tile group example and tile group information according to an embodiment of the present invention.

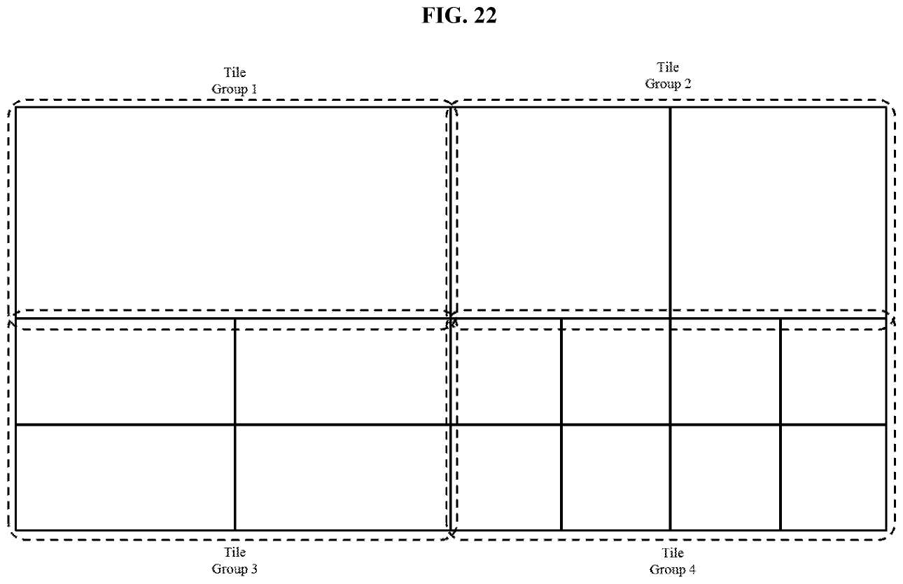

FIG. 21 is a view showing a partition tree structure partitioned into a plurality of tile groups according to an embodiment of the present invention, and FIG. 22 is an exemplary view showing partitioned tile groups.

Referring to FIG. 21, tile group information may indicate configuration information of tile groups and tiles in a picture on the basis of a tree structure, and according to the tile group information, an arbitrary picture 300 may be configured of a plurality of tile groups.

In order to effectively express and encode the configuration information of the tile groups, the tile group information may include configuration information of the tile groups in a picture in the form of a tree structure such as a binary tree, a ternary tree, or a quad tree.

For example, as corresponding components may be expressed according to the root, parent, and child nodes in a tree structure, parent node information corresponding to a tile group and child node information corresponding to each tile may be respectively specified in tile group header information in correspondence to the root node corresponding to a picture.

For example, in the tile group header information, information on the number of tile groups in a picture, encoding characteristic information commonly applied to the tile groups in the picture, and the like may be specified in tile group information corresponding to a picture node (root node).

In addition, information on the number of tiles in the tile group, information on the size of internal tiles, encoding characteristic information of each internal tile may be stored in the tile group header information, together with the group level information and the parallelization layer information corresponding to each tile group, in correspondence to the tile group node (parent node), and encoding information of each tile group that can be different from the encoding information commonly applied to or transferred from the root node and may be different even between tile groups may be specified.

Meanwhile, detailed encoding information of each tile may be included in the tile group header information, together with encoding information shared with each tile group node corresponding to a tile node (child node or terminal node). Accordingly, the encoding apparatus 10 may perform encoding by applying different encoding conditions to each tile even in the same tile group, and may include information thereon in the tile group header information.

Meanwhile, parallelization layer information of each tile group indicating a layer unit capable of performing parallelism may be included in the tile group header information for the purpose of parallelization processing, and the decoding apparatus 20 may selectively perform adaptive parallel decoding according to a decoding condition with reference to the parallelization layer information.

To this end, each of the tiles may be partitioned into the independent tiles or dependent tiles described above. Accordingly, the encoding apparatus 10 may encode independency information and dependency information of each tile group/tile and transfer the encoded information to the decoding apparatus 20, and the decoding apparatus 20 may determine whether or not parallelization processing can be performed between tiles on the basis of the transferred information, and adaptively perform high-speed parallelization processing optimized according to environment variables and performance.

Meanwhile, referring to FIG. 22, there may be one or more tile groups in a picture, and when the picture is partitioned into two or more tile groups, the number of tile groups may be restrictively defined according to a predefined rule, such as a multiple of 2, a multiple of 4, or the like.

In addition, the tile group information may include information on the number of divides of the tile group, and may be specified and encoded in the tile group header.

For example, when the number of tile groups is defined as T, a value converted into log₂(T) may be encoded in the tile group header.

Meanwhile, each tile group may include one or more tiles, and it may be determined whether or not to process the one or more tiles step by step in parallel according to the parallelization layer information. For example, the parallelization layer information may be expressed as depth information D in a tile group, and the number N of tiles in a tile group may be calculated in an exponential form of 2^{D}.

For example, the parallelization layer information may be set to a value of 0 or larger, and whether or not to perform partition and parallelization of tiles corresponding to the layer information may be variably determined.

For example, referring to FIG. 22, one tile group 1 may not be separately partitioned into two or more sub-tiles, and in this case, value 0 may be assigned as the parallelization layer information of tile group 1. At this point, the tile group 1 may be configured of one tile, and the tile may have a size the same as that of tile group 1.

Meanwhile, tile group 2 may include two tiles, and in this case, value 1 may be assigned as the parallelization layer information of the tile group.

In addition, tile group 3 may include four tiles, and in this case, value 2 may be assigned as the parallelization layer information of the tile group.

In addition, tile group 4 may include eight tiles, and in this case, value 3 may be assigned as the parallelization layer information of the tile group.

In addition, in this embodiment, a tile group may be described as a subpicture set, and a tile may be equally described as each subpicture, and level information and parallelization layer information corresponding to subpictures included in each subpicture set may be determined.

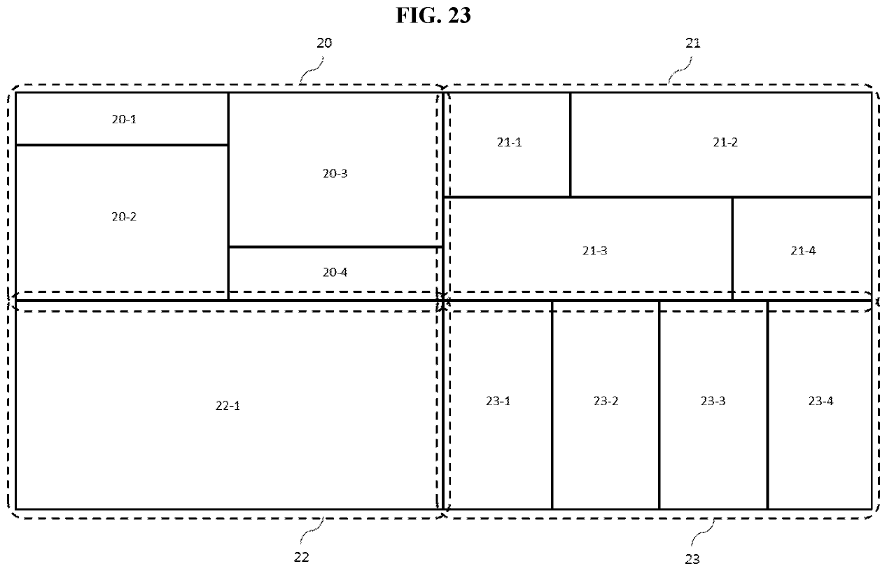

Meanwhile, FIG. 23 is a view showing various tile connection structures of a tile group proposed in the present invention.

A tile group according to an embodiment of the present invention may include one tile or a plurality of tiles as much as a multiple of 2 or 4, and to this end, the picture partition unit 110 may divide the tiles in various ways, and allocate tile groups configured of the partitioned tiles.

For example, as shown in FIG. 23, when a first tile group 20, a second tile group 21, a third tile group 22, and a fourth tile group 23 are allocated, the first tile group 20 may include tiles partitioned in a way of fixing the width (horizontal length) and variably partitioning the height (vertical length) of sub-tiles, and as the vertical length of the tiles may be further partitioned at a ratio of 1:2, 1:3, or the like, the size of the tiles in the tile group may be variously adjusted.

In addition, as shown in the second tile group 21, the tile group 21 may include tiles partitioned in a way of fixing the height (vertical length) and variably partitioning the width (horizontal length) of sub-tiles. In this case, the horizontal length may be further partitioned at a ratio of 1:2, 1:3, or the like, and the size of the tiles in the tile group may be variously adjusted.

Meanwhile, the third tile group 22 is an example of a group configured of one tile, and in this case, the size and shape of the tile 22-1 may be the same as the size and shape the tile group 22.

Meanwhile, the fourth tile group 23 is an example of configuring a tile group to have a plurality of tiles 23-1, 23-2, 23-3, and 23-4 of the same tile size, and each of the tiles 23-1, 23-2, 23-3, and 23-4 may have a rectangular shape extended in the vertical direction, and may configure one tile group 23. In addition, when the tile group is configured of tiles of the same size, one tile group may be configured in a rectangular shape extended in the horizontal direction.

Accordingly, the encoding apparatus 10 may set the shape and number of tiles in a tile group to be different from those of the other tile groups, and tile group information indicating the shape and number of a tile may be encoded through the tile group header and signaled to the decoding apparatus 20.

Accordingly, the decoding apparatus 20 may determine the shape and number of tiles in a tile group for each tile group on the basis of the tile group information. In addition, the partial decoding or parallelization processing process of the decoding apparatus 20 may be efficiently performed on the basis of the shape and number information of the tiles in the tile group. Here, since the level information relates to a performance and conformance test, information on the number of tiles included in a subpicture set corresponding to the tile group information may be used to determine the level information.

For example, in the case of the first tile group 20, the decoding apparatus 20 derives the horizontal length from the size of the first tile group 20 by assuming the size at a ratio of 1:1, and after the horizontal length is derived, the decoding apparatus 20 may derive the vertical length by obtaining ratio information (1:2, 1:3, etc.) or size information in the tile group information separately signaled to derive the vertical length. Here, information on the horizontal size or vertical size of each tile may be obtained as the information is converted and directly transferred to the decoding apparatus 20.

In addition, for example, in the case of the second tile group 21, the decoding apparatus 20 may derive the vertical length from the size of the second tile group 21 by assuming the size of the second tile group 21 at a ratio of 1:1, and determine the tile structure information of each tile group using horizontal length information in the separately signaled tile group information.

In addition, as shown in the fourth tile group 23, the decoding apparatus 20 may determine tile structure information of each tile group by equally partitioning the tile group in the vertical and horizontal directions on the basis of the overall size of the tile group and deriving the horizontal and vertical sizes of sub-tiles.

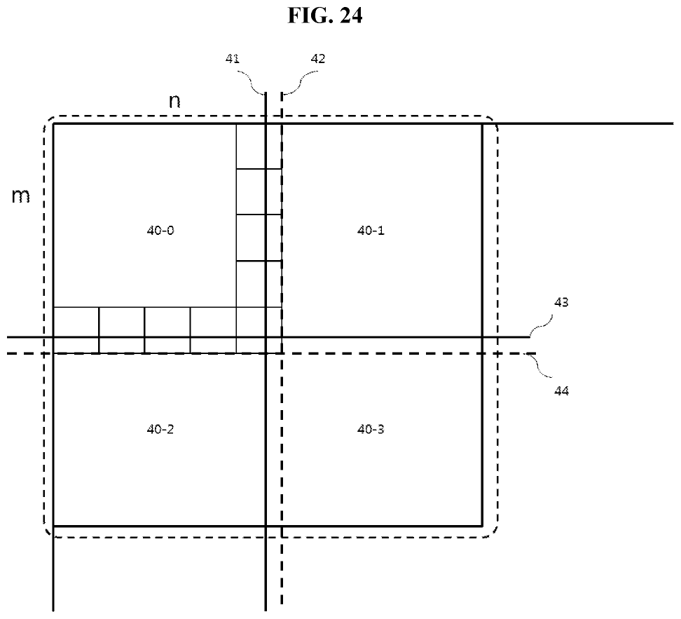

Meanwhile, FIG. 24 is a view showing a detailed process in a tile boundary area in performing an encoding process on the basis of tile group according to an embodiment of the present invention.

First, the encoding apparatus 10 according to an embodiment of the present invention may express information on the size of each tile as a numeric value such as Height (M), Width (N), or the like, encode the numeric information through a multiplication operation or a value obtained by performing log transformation on a result of the multiplication operation and include the encoded value in the header information, or perform a process of inducing the tile size through the number of CTUs in each tile to indicate the tiles included in the tile group information for each tile group.

For example, as the size of each tile may be a CTU unit in minimum and may be the same as the tile group unit in maximum, the size of a tile may be preferably defined as a multiple of 4 or 8 in the width and height within the range.

In addition, according to an embodiment of the present invention, there may be a case in which the tile size does not match the CTU unit according to setting of a tile or tile group size. For example, although it is general that tiles included in tile groups may coincide with the CTU boundary lines 42 and 44, there may be a case in which a tile or a tile group is partitioned (41, 43) not to coincide with the boundary lines between CTUs due to the boundary areas or the like of the picture.

Accordingly, first, when the boundary lines between the tile groups or the boundary lines of the tiles coincide with the CTU boundary lines, the encoding apparatus 10 may classify the tiles as independent tiles, and allows the decoding apparatus 20 to perform parallel decoding according to assignment of parallelization processes.

However, when the boundary of a tile group or the boundary of a tile does not coincide with the CTU boundaries, the encoding apparatus 10 may classify a tile including the starting position or the Left-Top(x, y) position of a boundary area CTU as an independent tile, and classify tiles adjacent thereto as dependent tiles.

In this case, the decoding apparatus 20 should decode the independent tiles first to prevent deterioration of image quality as the dependent tiles are decoded thereafter.

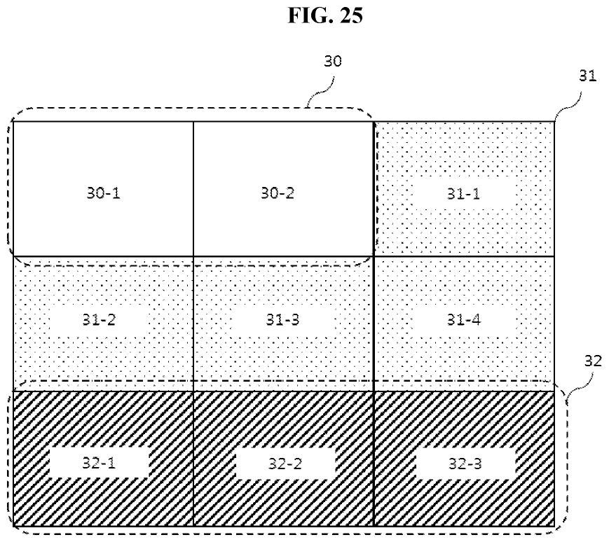

FIG. 25 is a view showing partition of an arbitrary picture into various tile groups according to an embodiment of the present invention. Each of the tile groups 30, 31, and 32 may be configured as a tile group including tiles, and the tile group identifier, parallelization layer information, and tile group level information described above may be assigned to each tile group, and tile group information according thereto may be signaled to the decoding apparatus 20.

Each of the tile groups 30, 31, and 32 may include a variable number of tiles, such as two, four, three, or the like, and the encoding apparatus 10 may determine and encode a tile group header according to encoding characteristics of each tile group and transmit the tile group header to the decoding apparatus 20. The tile group header may include encoding characteristic information such as on/Off information of various encoding tools (OMAF, ALF, SAO, etc.) of the tiles in the tile group.

The tile group header information may be configured in a form capable of deriving next tile group header information from tile group header information corresponding to the first tile in the picture.

For example, the encoding apparatus 10 may generate an option value, a differential signal, offset information or the like that are applied to be different from the header information of the first tile group in correspondence to the header information of the next tile group using the header information of the first tile group in a picture, and encode them to be sequentially updated in the header information of the next tile group. Accordingly, headers of all tile groups in the picture may be acquired through sequential update.

In addition, the encoding apparatus 10 may process to derive the encoding characteristic information applied to each tile group by the decoding apparatus 20 using an option difference value with the header information of a plurality of other tile groups 31 and 32 existing in the picture, a differential signal, or offset information on the basis of the header information of the first tile group 30 in the picture.

Meanwhile, the encoding apparatus 10 may perform encoding to update the tile group header information of other pictures in the group of picture (GOP) including an Instantaneous Decoding Refresh (IDR) picture on the basis of tile group header information of a picture in which the starting picture of the GOP is coded through IDR. This will be described below separately.

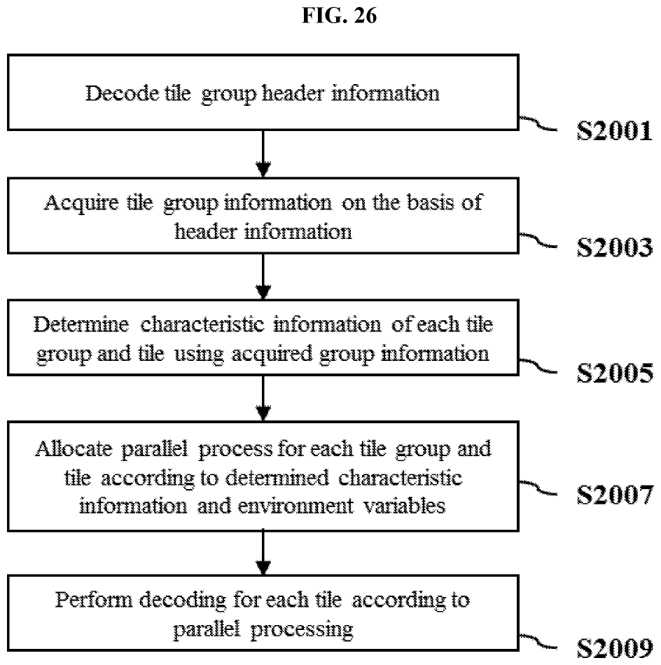

FIG. 26 is a flowchart illustrating a decoding process based on tile group information according to an embodiment of the present invention.

Referring to FIG. 26, first, the decoding apparatus 20 decodes tile group header information (S2001) and acquires tile group information based on the header information (S2003).

The decoding apparatus 20 may determine one or more tiles partitioning a picture of an image on the basis of the tile group information, and group the tiles to configure a plurality of tile groups.

Here, the decoding apparatus 20 may derive information on the configuration of the tiles in the tile group using location information of bottom-left and bottom-right CTUs separately transmitted or derived from the encoding apparatus 10.

In addition, in order to increase encoding efficiency, the encoding apparatus 10 may allow the decoding apparatus 20 to derive the configuration information of the tiles in the tile group using only the bottom-right CTU information.

For example, location information of the bottom-right CTU may be signaled to the decoding apparatus 20 through a separate flag value. In addition, the decoding apparatus 20 may regard the CTU located in the last row and last column of the tiles as the bottom-right CTU and derive the information using the configuration information of the rows and columns of the tiles.

At this point, the top-left CTU information may be defined using the location information of the CTU starting the tile. As described above, the decoding apparatus 20 may derive configuration information of a tile in a tile group using the bottom-left and bottom-right CTU location information, and although the same method is used even in the case of a plurality of tiles, the configuration information of the tiles in the tile group may be derived by setting a CTU having the boundary surface of a previous tile as the starting position as the starting CTU, and deriving the location information of the bottom-right CTU corresponding thereto.

Then, the decoding apparatus 20 may determine the characteristic information of each tile group and tile using the tile group information (S2005), allocate a parallel process to each tile group and tile according to the determined characteristic information and environment variables (S2007), and perform decoding on each tile according to the allocated parallel process (S2009).

More specifically, the tile group information may include tile group header information including structure information of each tile group, dependency or independency information between tiles in the tile group, group level information, and parallelization layer information.

On the basis of the characteristic information determined from the tile group information and environment variables of the decoding apparatus determined according to at least one among a system environment variable, a network variable, and a perspective variable, each of the tiles configured as a plurality of tile groups may be selectively decoded in parallel.

Particularly, the tile group information may be signaled from the encoding apparatus 10 as tile group header information, and stored and managed in the decoding apparatus 20, and according to the identification information of the group of picture including the picture, the tile group header information may be initialized or updated.

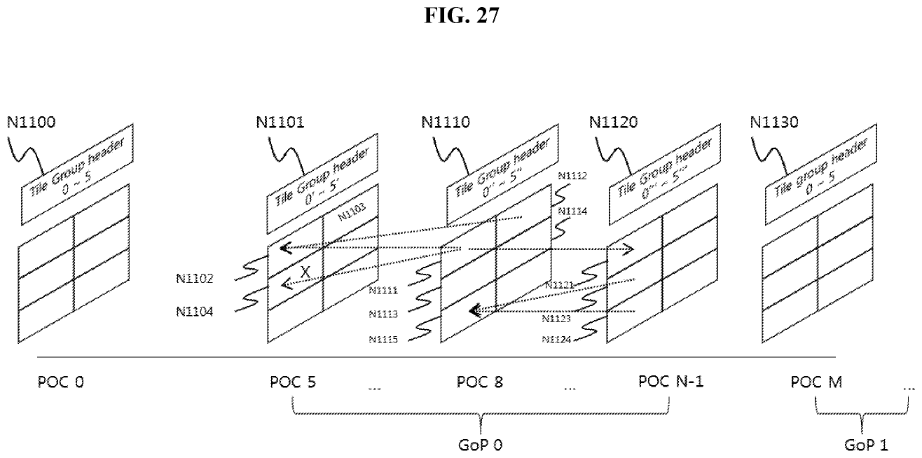

FIG. 27 is a flowchart illustrating the process of initializing a tile group header according to an embodiment of the present invention.

Referring to FIG. 27, when an image bitstream configured of a plurality of GOPs is acquired and processed by the decoding apparatus 20, the tile group header may be shared and updated within one GOP, and different tile group headers may be used in different GOPs according to initialization.

For example, when it is assumed that there is GOP 0 configured of N pictures, picture POC 0 of the GOP 0 may be a picture coded through Instantaneous Decoding Refresh (IDR), and the decoding apparatus 20 may store initial six tile group headers corresponding to picture POC 0. At this point, each tile group header may be classified by a unique tile group ID.

In addition, each tile group header may include location information or address information of the top-left CTU and location information or address information of the bottom-right CTU of each tile group in a picture as unique information, and in this case, the decoding apparatus 20 may determine the structure of the tile group using the location information.

More specifically, the tile group header N1101 of POC 5 may include header information of a total of six tile groups, and each tile group header information may be classified by a unique ID.

In addition, each tile group header information between the pictures included in a specific GOP may be independently acquired or dependently derived and processed.

For example, referring to FIG. 27, in order to derive information on the tile group header N1101 of POC 5, the decoding apparatus 20 may first use header information decoded from the first tile group header N1100 of POC 0 as it is.

In addition, in order to acquire the configuration information of the tiles in each tile group, the decoding apparatus 20 may determine the size and shape information of tile group N1102 using the location information of the top-left CTU and the bottom-right CTU of tile group N1102.

Then, the decoding apparatus 20 may acquire tile group information of the second tile group N1103 of POC 5.

Meanwhile, the decoding apparatus 20 may derive the tile group header N1110 of POC 8 with reference to the previously encoded tile group header information.

For example, when POC 0 and POC 8 are located in the same GOP, the configuration of the tile group in the picture may be maintained the same, and therefore, tile group configuration information of POC 8 (the number of tile groups, location information of the top-left CTU in a tile group, and location information of the bottom-right CTU in a tile group) may be derived from the tile group header information of the IDR picture (POC 0) in the same way.

Then, the basic tile group configuration information and encoding condition information of the tile group header N1110 of POC 8 are derived from the tile group header N1101 of POC 5, and adaptive decoding may be selectively performed for each tile group using offset information additionally signaled from the encoding device 10 by subdividing and determining filtering conditions (ALF, SAO, deblocking filter) for each tile group of POC 8, subdividing different Delta QPs for each tile group, or subdividing and applying inter-screen prediction encoding tools (OMAF, Affine, etc.).

In addition, as tile group header N1120 of POC N-1 may also be derived and acquired from the previously decoded tile group header N1110 of POC 8 or tile group header N1101 of POC 5, the decoding apparatus 20 may derive detailed encoding conditions for each tile group of picture POC N-1 by acquiring only the difference information to be updated from the previously decoded tile group header information according to the decoding order or occurrence of an event such as acquisition of a network unit type.

Meanwhile, the IDR picture POC M of another GOP 1 may be independently decoded, and to this end, tile group header N1130 configuring the POC M may be separately specified. Accordingly, different tile group structures may be formed among different GOPs.

In addition, the decoding apparatus 20 may perform a partially parallel decoding process using the tile group level information and the tile group type information.

For example, as described above, each tile group may be specified to have a different tile group level. For example, according to the tile group level, a tile group may be classified as an independent tile group when the tile group level is 0, and as a non-independent tile (dependent tile) group when the tile group level is 1.

In addition, the tile group information may include tile group type characteristic information, and the tile group type may be classified into I, B, and P types.

First, when a tile group of I-type is specified to have an independent tile group level, it may mean that decoding should be performed through intra-screen prediction within a tile group without referring to different tile groups.

In addition, when a tile group of I-type is specified to have a dependent tile group level, it may mean that although the image of the corresponding tile group is decoded through intra-screen prediction, decoding should be performed with reference to an adjacent independent tile group.

Meanwhile, although a tile group of B or P type may indicate that image decoding is performed through intra-screen prediction or inter-screen prediction, a reference area and range may be determined according to the tile group level.

First, in the case of a tile group of B or P type specified to have an independent tile group level, the decoding apparatus 20 may perform intra-screen prediction decoding in a range within an independent tile group when intra-screen prediction is performed.

In addition, in the case of a tile group of B or P type specified to have a dependent tile group level, the decoding apparatus 20 may perform decoding with reference to decoding information of a tile group defined as an independent tile group among previously decoded pictures when inter-screen prediction is performed.

For example, when the characteristic of a tile group specified to have a dependent tile group level is a B or P type, the decoding apparatus 20 may perform decoding with reference to decoding information of a previously decoded adjacent tile group when intra-screen prediction is performed, and may perform motion compensation processing by setting a reference area from a previously decoded independent tile group when inter-screen prediction is performed.

For example, in the case where N1102 of a specific POC 5 and N1121 of PIC N-1 are independent tile groups and tile groups decoded before PIC 8, and N1111 is an independent tile, the decoding apparatus 20 may perform inter-screen prediction decoding with reference to N1102 and N1121 for tile group N1111 to be decoded when the tile group level of tile group N1111 to be decoded is 0 and the type is B. On the other hand, in the case of a non-independent tile group such as N1104 of PIC 5, the decoding apparatus 20 may not decode N1111 with reference to N1104.

In addition, when the tile group level of N1112 of PIC 8 is 1 and the type is B or P, the decoding apparatus 20 may determine tile group N1112 as a non-independent (dependent) tile group, and the reference area of the intra-screen prediction decoding may be limited to adjacent previously decoded tile groups. For example, when N1111 is previously decoded, the decoding apparatus 20 may perform intra-screen prediction decoding on N1112 with reference to N1111. In addition, in performing the inter-screen prediction decoding, the decoding apparatus 20 may perform inter-screen prediction decoding on N1112 with reference to N1102, of which the level of the tile group is 0, among previously decoded areas.

As described above, in the present invention, the reference structure in the intra-screen and inter-screen prediction structures may be limited or specified using the tile group level and the tile group type information, and therefore, partial decoding of a tile group unit on an arbitrary picture may be perform efficiently.

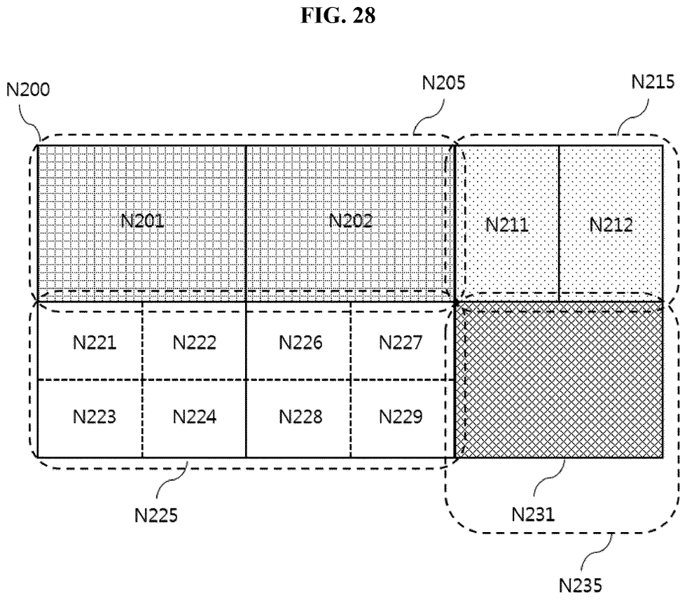

FIG. 28 is a view for explaining variable parallel processing based on parallelization layer units according to an embodiment of the present invention.

Referring to FIG. 28, when a picture N200 is partitioned into four tile groups N205, N215, N225, and N235, the tile group N205 is configured of two lower tiles N201 and N202, and N215 and N235 may be configured of the two tiles N211 and N212 and one tile N231 tile, respectively. In addition, like tile group N225, one tile group may be configured of eight tiles N221 to N224 and N226 to N229.

As described above, a tile group may be configured of one or more tiles. In addition, the size and encoding characteristics of a tile may be diversely determined, and the characteristics and configuration information of a tile in a tile group may be explicitly encoded and signaled, or may be indirectly derived by the decoding apparatus 20.

A method of explicitly encoding and signaling may include, for example, a method of signaling structure information of a tile by specifying size information (width/height) of lower tiles in the tile group or first CTU location information of the lower tiles, the number of columns and rows of the tiles, the number of CTUs in a tile, and the like in the tile group header or using the location information of the first (top-left) CTU and the last (bottom-right) CTU in the tile.

A method of indirectly deriving the characteristics and configuration information may include, for example, a method of allowing the decoder to grasp whether or not a tile is partitioned according to whether the encoding information of the first CTU of each tile is dependent on previous encoding information.

In addition, according to an embodiment of the present invention, the decoding apparatus 20 may perform effective parallel decoding, which maximally makes use of performance of the decoding apparatus 20, on an image partitioned into tile groups and tiles and encoded as shown in FIG. 28 using the tile group level information and tile parallelization layer information described above in combination.

For example, since the encoding apparatus 10 may divide an arbitrary picture into a plurality of tile groups according to image characteristic information or the intention of an image manufacturer or service provider, the encoding apparatus 10 may remove the dependency occurring due to the prediction and reference between tile groups, and initialize encoded data, such as the adaptive arithmetic encoding data, MVP buffer, prediction candidate list and the like, shared with neighboring blocks in the tile.

In addition, the encoding apparatus 10 may encode a plurality of tile groups so that the tile groups may be allocated to and decoded by parallel processing processes in the decoding apparatus 20, respectively. For example, in the encoding apparatus 10, single encoding may be performed by allocating a single core or thread, or four cores may be allocated to N205, N215, N225, and N235, respectively, to perform encoding in parallel.

In addition, according to the encoding processing information, the encoding apparatus 10 may allocate tile group level information and parallelization layer information, for which a parallel process may be individually assigned by the decoding apparatus 20, as tile group information, and transfer the allocated information to the decoding apparatus 20.

Accordingly, the decoding apparatus 20 basically performs parallel processing processed by the encoding apparatus 10, and may also perform further subdivided additional parallel processing or partial decoding processing according to the performance and environment variables.

For example, the encoding processing information may include image projection format information of a 360-degree image, view port information of an image, and the like, and the encoding apparatus 10 may map image area information capable of performing parallel/sub-decoding or partial decoding according to the intention of the image manufacturer or service provider to tile group information according to the importance or ROI information of a specific tile group image.

For example, an encoding target image is configured of an omnidirectional image such as a 360-degree image, and as a specific view port image in an input image corresponds to or is mapped to a tile group in the picture, the decoding apparatus 20 may perform parallel decoding or partial decoding.

The parallelization layer information for this purpose may indicate whether a stepwise and additional parallel processing process can be allocated to the tiles in the tile group, and specifically may include minimum or maximum parallelization layer level information.

Accordingly, the decoding apparatus 20 may determine whether or not to allocate a plurality of cores/threads according to the number of lower tiles in one tile group using the parallelization layer information, and may perform partial decoding according to user perspective by individually determining whether independent/dependent decoding is possible for an arbitrary tile group or tiles within the tile group using the tile group level information.

For example, the decoding apparatus 20 may determine step by step whether or not to additionally perform parallel processing partitioned in units of layers on the tiles in a tile group according to the parallelization layer information.

For example, when the parallelization layer unit information is 0, the decoding apparatus 20 may not be able to perform an additional parallel process on the tiles in a tile group. In this case, a tile group level including only dependent tiles may be allocated to the tile group.

On the other hand, when the parallelization layer value is 1, the decoding apparatus 20 may perform a one-time additional parallel process on the sub-tiles in a tile group. In this case, a tile group level configured of only independent tiles or a tile group level including independent tiles and dependent tiles may be allocated to the tiles configuring the tile group.

Meanwhile, according to the tile group level, the decoding apparatus 20 may perform a process of classifying major images or partial images, or may determine whether an independent tile or a dependent tile exists in a tile group.

For example, when the value of a tile group level is set to 0, all the tiles in the tile group may be indicated as independent tiles, and the decoding apparatus 20 may classify the tiles as a major image tile group.

In addition, when the tile group level is set to 1, the first tile of the tile group may be indicated as an independent tile and the remaining tiles may be indicated as dependent tiles, and the decoding apparatus 20 may classify and process the tiles as a non-major image tile group.

In addition, when the tile group level is set to 2, all the tiles in the tile group are indicated as dependent tiles, and the decoding apparatus 20 may perform a decoding process with reference to decoding information of previously decoded neighboring tile groups or neighboring tiles.

Accordingly, the decoding apparatus 20 may perform high-speed parallel decoding in units of frames by allocating a parallel thread corresponding to the tiles configuring the tile group according to the parallelization layer unit.

In addition, the decoding apparatus 20 may determine tile groups corresponding to major images or major view ports according to the system environment, network situations, change in user perspective or the like, and when the decoder determines an area capable of performing partial decoding, partial decoding in a picture corresponding to a specific view port may be independently performed.

For example, referring to FIG. 28, as the decoding apparatus 20 may allocate two parallel decoding processes (cores) corresponding to N205 to N201 and N202, eight cores corresponding to N225 to N221 to N224 and N226 to N229, two cores corresponding to N215 to N211 and N212, and one core corresponding to N235 to N231, parallel decoding may be performed by allocating up to 13 cores. In addition, the decoding apparatus 20 may perform parallel decoding using a total of four cores by allocating one core to each of the four tile groups corresponding to N205, N215, N225, and N235 according to the performance and environment variables, or may perform single-core decoding on the entire picture using one core.

In addition, for example, when the tile group level of a specific tile group N205 is set high, the decoding apparatus 20 may classify the corresponding part as a major image, and when N215 is set low, the decoding apparatus 20 may classify the corresponding part as a non-major image, and among the tiles in N215, N211 may be classified as an independent tile, and N212 as a dependent tile.

In this case, the decoding apparatus 20 may process an omnidirectional image, such as a 360-degree image, to be linked to a tile group, and particularly, according to the intention of a contents manufacturer or a user (visual reaction, motion reaction), the decoding apparatus 20 may classify only a part of a tile group in a picture as a major image and perform partial high-speed parallel decoding.

For example, when it is assumed that N225 is a front image, N205 is a left-right image (N201 (right), N202 (left)), and N215 and N235 are diagonal and rear images, respectively, the decoding apparatus 20 may selectively and partially decode only the front image N225 and the left-right image N205 according to a change in the user perspective or the like, and perform parallel decoding on the four tile groups N205, N215, N225, and N235, and at the same time, the decoder may perform single-core decoding using one or four cores or parallel decoding using four cores.

In this way, as one or more parallel processing processes are variably assigned on the basis of the parallelization layer information of the tile group and the tile group level information, decoding can be performed efficiently.

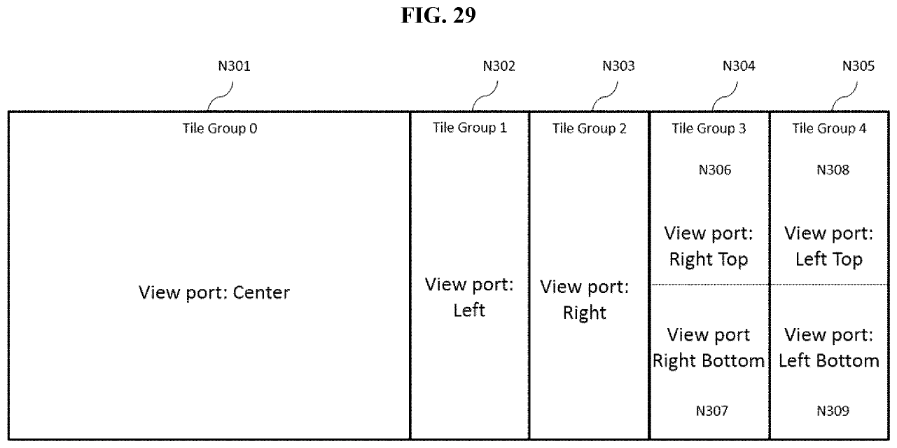

FIG. 29 is a view for explaining a case of mapping tile group information and user perspective information according to an embodiment of the present invention.

Referring to FIG. 29, a picture may be configured of five arbitrary tile groups N301, N302, N303, N304, and N305, and these are perspective information of an image and may correspond to view ports.

For example, a tile group may correspond to one or a plurality of view ports. As shown in FIG. 29, N301 may be mapped to a Center view port, N302 may be mapped to a Left view port, N303 may be mapped to a Right view port, N304 may be mapped to a Right-Top and Right-Bottom view port images, and N305 may be mapped to a Left-Top and Left-Bottom view port images.

In addition, a plurality of view ports may be mapped to one tile group, and at this point, each view port may be mapped to each tile in the tile group. For example, N304 and N305 may be tile groups configured of two view port tiles (N304 includes N306 and N307, and N305 includes N308 and N309), respectively.

In addition, tiles N306 and N307 of tile group N304 may be mapped to view ports of two different perspectives (Right Top and Right Bottom).

The decoding apparatus 20 may process partial expansion and transform of an image using tile group information. The tile group header may include mapping information corresponding to the view port or perspective information of the image, and may further include whether partial decoding is performed according to movement of user perspective, and scale information or rotation transform (90-degree, 180-degree, or 270-degree transform) information for processing resolution expansion of the image.

The decoding apparatus 20 may decode and output an image obtained by performing image resolution adjustment and image rotation on a partial image in a tile group using the rotation transform and scale information.

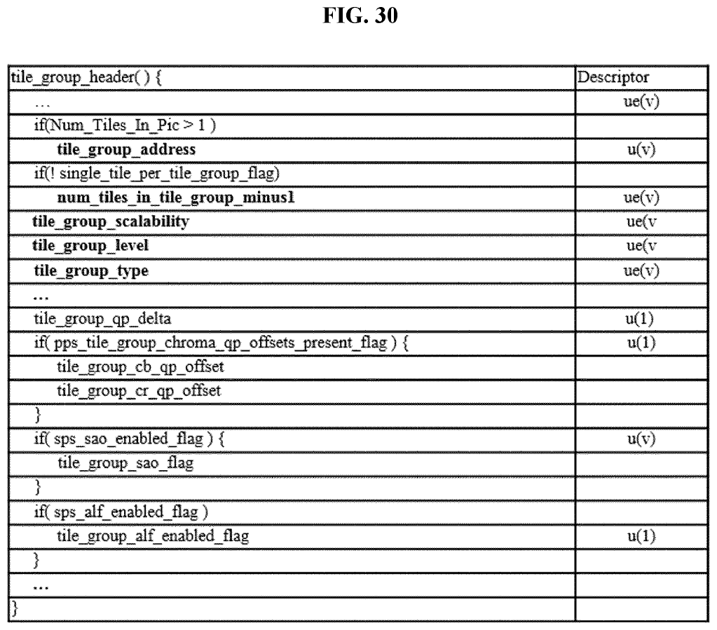

FIG. 30 is a view showing syntax of tile group header information according to an embodiment of the present invention.

Referring to FIG. 30, tile group header information may include at least one among tile group address information, information on the number tiles in a tile group, parallelization layer information, tile group level information, tile group type information, tile group QP delta information, tile group QP offset information, tile group SAO information, and tile group ALF information.

First, the tile group address Tile_group_address information may indicate the address of the first tile in a tile group when an arbitrary picture is configured of a plurality of tile groups. The boundary of a tile group or the first tile in the tile group may be derived using the location of the first CTU located at the upper left and the address of the CTU located at the lower right.

In addition, the single tile flag Single_tile_per_tile_group_flag information is flag information for confirming the configuration information of the tiles in a tile group. When the value of Single_tile_per_tile_group flag is 0 or False, it may mean that the tile group in the picture is configured of a plurality of tiles. Alternatively, when the value of Single_tile_per_tile_group_flag is 1 or True, it may mean that the corresponding tile group is a tile group configured of one tile.

In addition, the parallelization layer information may be indicated as tile group scalability Tile_group_scalability information, and this may mean a unit of minimum or maximum parallel process that can be allocated to the tiles in a tile group. Through the value, the number of threads that can be allocated to the tiles in a tile group may be adjusted.

Meanwhile, the tile group level information Tile_group_level may indicate whether an independent tile and a dependent tile exist in a tile group. The tile group level information may be used to indicate whether all the tiles in a tile group are independent tiles, independent and non-independent (dependent) tiles, or non-independent (dependent) tiles.

The tile group type information Tile_group_type may be classified as I, B, or P type tile group characteristic information, and it may mean various encoding methods and restrictions such as the prediction method, prediction mode, and the like in which a corresponding tile group is encoded according to each type structure.

Meanwhile, tile group QP delta information, tile group QP offset information, tile group SAO information, tile group ALF information, and the like may be exemplified as encoding information, and on/off information for various encoding tools in a tile group may be specified in the tile group header as separate flag information. The decoding apparatus 20 may derive information on the encoding tool for all tiles in a tile group currently being decoded, or may derive encoding information of some tiles among the tiles in a tile group through a separate operation process.

The method according to the present invention described above may be manufactured as a program to be executed on a computer and stored in a computer-readable recording medium, and examples of the computer-readable recording medium include ROM, RAM, CD-ROM, magnetic tapes, floppy disks, optical data storage devices and the like, and also include those implemented in the form of a carrier wave (e.g., transmission through the Internet).

The computer-readable recording medium may be distributed in computer systems connected through a network, so that computer-readable codes may be stored and executed in a distributed manner. In addition, functional programs, codes, and code divides for implementing the method may be easily inferred by the programmers in the art to which the present invention belongs.

In addition, although preferred embodiments of the present invention have been illustrated and described above, the present invention is not limited to the specific embodiments described above, and various modified embodiments can be made by those skilled in the art without departing from the gist of the invention claimed in the claims, and in addition, these modified embodiments should not be understood individually from the spirit or perspective of the present invention.

1. An image decoding method comprising the steps of:
decoding subpicture information and processing a plurality of subpictures that include tiles or slices partitioning a picture of an image and cover a specific area of the picture; and
identifying the plurality of subpictures and decoding each of the tiles or slices configuring the subpictures on the basis of the subpicture information, wherein
subpicture information includes level information indicating processing levels corresponding to the plurality of subpictures.

2. The method according to claim 1, wherein the level information is used for a processing conformance test on a bitstream including the subpictures.

3. The method according to claim 2, wherein the processing conformance test on a bitstream includes a process of determining a processing step of the bitstream according to the level information and environment variables.

4. The method according to claim 2, wherein the level information is determined according to information on the number of tiles included in a subpicture set including the subpictures.

5. The method according to claim 2, wherein the level information is transmitted after being included in an SEI message corresponding to the bitstream.

6. The method according to claim 2, wherein the level information includes information on a maximum or minimum layer unit indicating a level capable of processing the tiles included in each subpicture.

7. The method according to claim 6, wherein the layer unit information indicates that the tiles in the subpicture may be partitioned and processed as much as a level corresponding to the layer unit information.

8. The method according to claim 2, wherein whether or not subpictures included in an encoded subpicture set can be decoded is variably determined by a conformance test process based on the level information in a decoding apparatus that decodes the subpictures.

9. The method according to claim 2, wherein the conformance test process includes a process of determining whether or not to process the subpictures or a processing step of the subpictures on the basis of the level information and environment variables of the decoding apparatus.

10. The method according to claim 9, wherein the environment variables of the decoding apparatus are determined according to at least one among a decoding environment variable, a system environment variable, a network variable, and a user perspective variable.

11. The method according to claim 1, wherein the tiles or slices include a plurality of coding tree units (CTUs), which are basic units for partitioning the picture, the coding tree unit is partitioned into one or more coding units (CUs), which are basic units for performing inter prediction or intra prediction, the coding unit is partitioned into at least one among a quad tree structure, a binary tree structure, and a ternary tree structure, and the subpicture includes a specific rectangular area in the picture formed by continuously arranging the tiles or slices.

12. An image decoding apparatus comprising:
a picture partition processor decoding subpicture information for processing a plurality of subpictures that include tiles or slices partitioning a picture of an image and cover a specific area of the picture; and
a decoding processor identifying the plurality of subpictures and decoding each of the tiles or slices configuring the subpictures on the basis of the subpicture information, wherein
the subpicture information includes level information indicating processing levels corresponding to the plurality of subpictures.
